(19) United States
(12) Patent Application Publication
(10) Pub. No.: US 2025/0363987 A1
(43) Pub. Date: Nov. 27, 2025

(54) SYNCHRONIZING RESPONSES WITH DISPLAY CONTENT

(71) Applicant: Apple Inc., Cupertino, CA (US)

(72) Inventors: Kristen W. KWONG, Pittsburgh, PA (US); Pierre BELIN, Lynnwood, WA (US); Thomas D. MARTIN, Pittsburgh, PA (US); Jiajie SHI, Seattle, WA (US)

(21) Appl. No.: 19/203,083

(22) Filed: May 8, 2025

Related U.S. Application Data
(60) Provisional application No. 63/650,868, filed on May 22, 2024.
(60) Provisional application No. 63/657,484, filed on Jun. 7, 2024.
(60) Provisional application No. 63/730,879, filed on Dec. 11, 2024.

(51) Int. Cl. G10L 15/22; G06F 3/16

(52) U.S. Cl. CPC G10L 15/22; G06F 3/167; G10L 2015/223

(57) ABSTRACT

Systems and processes for operating an intelligent automated assistant are provided. For example, in response to a user request, a digital assistant provides a spoken output and a visual output, which is visibly updated at least once during the provision of the spoken output. For example, in response to a user request, a multi-element response, including a multi-element dialog output and multiple different display instructions, is generated and output, where the multiple different display instructions are executed while outputting the multi-element dialog output.

### CROSS-REFERENCE TO RELATED APPLICATIONS

This application claims priority to U.S. Provisional Patent Application Ser. No. 63/650,868, entitled “SYNCHRONIZING RESPONSES WITH DISPLAY CONTENT,” filed on May 22, 2024, U.S. Provisional Patent Application Ser. No. 63/657,484, entitled “SYNCHRONIZING RESPONSES WITH DISPLAY CONTENT,” filed on Jun. 7, 2024, and U.S. Provisional Patent Application Ser. No. 63/730,879, entitled “SYNCHRONIZING RESPONSES WITH DISPLAY CONTENT,” filed on Dec. 11, 2024. The contents of each of these applications are hereby incorporated by reference in their entirety.

### FIELD

This relates generally to intelligent automated assistants and, more specifically, to synchronizing multi-part responses to user requests with display content.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user. For example, the relevant output may include spoken content (e.g., a natural-language speech output synthesized by the digital assistant system) and visual content (e.g., text, images, icons, user interface elements, and/or other graphical components displayed via the electronic device).

### SUMMARY

Example methods are disclosed herein. An example method includes, at an electronic device having one or more processors and memory: receiving a user request directed to a digital assistant system; in response to receiving the user request directed to the digital assistant system, outputting, via the digital assistant system, a speech output; and causing display, via a display generation component, of a visual output, wherein causing the display of the visual output includes: in accordance with a determination that synchronization criteria are satisfied: causing display of the visual output in a first display state at a first time while outputting the speech output; and causing display of the visual output in a second display state, different from the first display state, at a second time, different from the first time, while outputting the speech output.

Example non-transitory computer-readable media are disclosed herein. An example non-transitory computer-readable storage medium stores one or more programs. The one or more programs comprise instructions, which when executed by one or more processors of an electronic device, cause the electronic device to receive a user request directed to a digital assistant system; in response to receiving the user request directed to the digital assistant system, output, via the digital assistant system, a speech output; and cause display, via a display generation component, of a visual output, wherein causing the display of the visual output includes: in accordance with a determination that synchronization criteria are satisfied: causing display of the visual output in a first display state at a first time while outputting the speech output; and causing display of the visual output in a second display state, different from the first display state, at a second time, different from the first time, while outputting the speech output.

Example electronic devices are disclosed herein. An example electronic device comprises one or more processors; a memory; and one or more programs, where the one or more programs are stored in the memory and configured to be executed by the one or more processors, the one or more programs including instructions for receiving a user request directed to a digital assistant system; in response to receiving the user request directed to the digital assistant system, outputting, via the digital assistant system, a speech output; and causing display, via a display generation component, of a visual output, wherein causing the display of the visual output includes: in accordance with a determination that synchronization criteria are satisfied: causing display of the visual output in a first display state at a first time while outputting the speech output; and causing display of the visual output in a second display state, different from the first display state, at a second time, different from the first time, while outputting the speech output.

An example electronic device comprises means for receiving a user request directed to a digital assistant system; means for, in response to receiving the user request directed to the digital assistant system, outputting, via the digital assistant system, a speech output; and means for causing display, via a display generation component, of a visual output, wherein causing the display of the visual output includes: in accordance with a determination that synchronization criteria are satisfied: causing display of the visual output in a first display state at a first time while outputting the speech output; and causing display of the visual output in a second display state, different from the first display state, at a second time, different from the first time, while outputting the speech output.

Example methods are disclosed herein. An example method includes, at an electronic device having one or more processors and memory: receiving a user request; in response to receiving the user request, generating a response to the user request, wherein generating the response to the user request includes: determining a plurality of response elements including a first response element and a second response element that is different from the first response element; generating a dialog output including a plurality of utterances, wherein the plurality of utterances includes a first utterance corresponding to the first response element and a second utterance corresponding to the second response element; and generating a plurality of display instructions, wherein the plurality of display instructions includes a first display instruction for displaying a first visual output corresponding to the first response element and a second display instruction for displaying a second visual output corresponding to the second response element; and outputting the response to the user request, wherein outputting the response includes: outputting, via an audio output device, the dialog output; and while outputting the dialog output, executing the plurality of display instructions.

Example non-transitory computer-readable media are disclosed herein. An example non-transitory computer-readable storage medium stores one or more programs. The one or more programs comprise instructions, which when executed by one or more processors of an electronic device, cause the electronic device to receive a user request; in response to receiving the user request, generate a response to the user request, wherein generating the response to the user request includes: determining a plurality of response elements including a first response element and a second response element that is different from the first response element; generating a dialog output including a plurality of utterances, wherein the plurality of utterances includes a first utterance corresponding to the first response element and a second utterance corresponding to the second response element; and generating a plurality of display instructions, wherein the plurality of display instructions includes a first display instruction for displaying a first visual output corresponding to the first response element and a second display instruction for displaying a second visual output corresponding to the second response element; and output the response to the user request, wherein outputting the response includes: outputting, via an audio output device, the dialog output; and while outputting the dialog output, executing the plurality of display instructions.

Example electronic devices are disclosed herein. An example electronic device comprises one or more processors; a memory; and one or more programs, where the one or more programs are stored in the memory and configured to be executed by the one or more processors, the one or more programs including instructions for receiving a user request; in response to receiving the user request, generating a response to the user request, wherein generating the response to the user request includes: determining a plurality of response elements including a first response element and a second response element that is different from the first response element; generating a dialog output including a plurality of utterances, wherein the plurality of utterances includes a first utterance corresponding to the first response element and a second utterance corresponding to the second response element; and generating a plurality of display instructions, wherein the plurality of display instructions includes a first display instruction for displaying a first visual output corresponding to the first response element and a second display instruction for displaying a second visual output corresponding to the second response element; and outputting the response to the user request, wherein outputting the response includes: outputting, via an audio output device, the dialog output; and while outputting the dialog output, executing the plurality of display instructions.

An example electronic device comprises means for receiving a user request; means for, in response to receiving the user request, generating a response to the user request, wherein generating the response to the user request includes: determining a plurality of response elements including a first response element and a second response element that is different from the first response element; generating a dialog output including a plurality of utterances, wherein the plurality of utterances includes a first utterance corresponding to the first response element and a second utterance corresponding to the second response element; and generating a plurality of display instructions, wherein the plurality of display instructions includes a first display instruction for displaying a first visual output corresponding to the first response element and a second display instruction for displaying a second visual output corresponding to the second response element; and means for outputting the response to the user request, wherein outputting the response includes: outputting, via an audio output device, the dialog output; and while outputting the dialog output, executing the plurality of display instructions.

Example methods are disclosed herein. An example method includes, at an electronic device having one or more processors and memory: receiving a user request; in response to receiving the user request, generating a dialog output based on the user request; annotating the dialog output with a first set of one or more element identifiers; outputting the dialog output; and while outputting the dialog output, providing a respective event identifier including a respective element identifier of the first set of one or more element identifiers to a respective application, wherein providing the respective event identifier to the respective application includes: in accordance with a determination that a first set of one or more criteria is satisfied, providing a first event identifier including a first element identifier of the first set of one or more element identifiers to a first application, wherein the first set of one or more criteria includes a criterion that is satisfied when the first element identifier is included in a second set of one or more element identifiers associated with a user interface of the first application.

Example non-transitory computer-readable media are disclosed herein. An example non-transitory computer-readable storage medium stores one or more programs. The one or more programs comprise instructions, which when executed by one or more processors of an electronic device, cause the electronic device to receive a user request; in response to receiving the user request, generate a dialog output based on the user request; annotate the dialog output with a first set of one or more element identifiers; output the dialog output; and while outputting the dialog output, provide a respective event identifier including a respective element identifier of the first set of one or more element identifiers to a respective application, wherein providing the respective event identifier to the respective application includes: in accordance with a determination that a first set of one or more criteria is satisfied, providing a first event identifier including a first element identifier of the first set of one or more element identifiers to a first application, wherein the first set of one or more criteria includes a criterion that is satisfied when the first element identifier is included in a second set of one or more element identifiers associated with a user interface of the first application.

Example electronic devices are disclosed herein. An example electronic device comprises one or more processors; a memory; and one or more programs, where the one or more programs are stored in the memory and configured to be executed by the one or more processors, the one or more programs including instructions for receiving a user request; in response to receiving the user request, generating a dialog output based on the user request; annotating the dialog output with a first set of one or more element identifiers; outputting the dialog output; and while outputting the dialog output, providing a respective event identifier including a respective element identifier of the first set of one or more element identifiers to a respective application, wherein providing the respective event identifier to the respective application includes: in accordance with a determination that a first set of one or more criteria is satisfied, providing a first event identifier including a first element identifier of the first set of one or more element identifiers to a first application, wherein the first set of one or more criteria includes a criterion that is satisfied when the first element identifier is included in a second set of one or more element identifiers associated with a user interface of the first application.

An example electronic device comprises means for receiving a user request; means for, in response to receiving the user request, generating a dialog output based on the user request; annotating the dialog output with a first set of one or more element identifiers; means for outputting the dialog output; and means for, while outputting the dialog output, providing a respective event identifier including a respective element identifier of the first set of one or more element identifiers to a respective application, wherein providing the respective event identifier to the respective application includes: in accordance with a determination that a first set of one or more criteria is satisfied, providing a first event identifier including a first element identifier of the first set of one or more element identifiers to a first application, wherein the first set of one or more criteria includes a criterion that is satisfied when the first element identifier is included in a second set of one or more element identifiers associated with a user interface of the first application.

Generating and synchronizing multi-part responses to user requests with display content provides improved, more efficient control of electronic devices. For example, when responding to a user request, updating a visual component of the response multiple times while outputting different parts of a spoken component of the response reinforces the content of the spoken component for the user (e.g., improving the user experience with a digital assistant response). Doing so also improves the adaptability of digital assistant systems, for example, providing flexibility to update the visual component differently based on device type, user proximity, response content, and other context. Providing multi-part responses to user requests in a clear, legible, and context-appropriate manner, as described herein, improves user confidence in system responses and allows the system to operate more efficiently (e.g., spending less time, requiring fewer inputs, and requiring less cognitive burden on the user when interacting with the system). Additionally, generating and synchronizing responses to user requests with applications by providing the applications with response event information provides improved control of electronic devices by efficiently leveraging application capabilities to reinforce user understanding of the response and to surface relevant application content without the user needing to manually control the application separately from the user request, improving the user experience with the digital assistant response.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4A is a block diagram of an exemplary multifunction device with a display and a touch-sensitive surface, according to various examples.

FIGS. 4B-4G illustrate the use of Application Programming Interfaces (APIs) to perform operations.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 7D illustrates a foundation model, according to various examples.

FIGS. 8A-8H illustrate systems for generating and synchronizing multi-part responses to user requests with display content, according to various examples.

FIG. 9 illustrates a flow diagram for synchronizing multi-part responses to user requests with display content, according to various examples.

FIGS. 10A-10B illustrate a flow diagram for generating multi-part responses with spoken and displayed elements, according to various examples.

FIG. 11 illustrates a block diagram of a system for generating responses with application integration, according to various examples.

FIGS. 12A-12I illustrate systems for generating responses with application integration, according to various examples.

FIG. 13 illustrates a flow diagram for generating responses with application integration, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

In some embodiments, in response to receiving a digital assistant request from a user, the digital assistant system outputs a multi-part spoken response to the request. A visual response is also provided in response to the request, and, while outputting the spoken response, the digital assistant system also causes the visual response to update multiple times, such that the visual response is displayed in one way while one part of the spoken response is output and displayed in a different way while another part of the spoken response is output. In some embodiments, in response to receiving a request from a user, a multi-part response including both dialog and display content is generated and output. In particular, the dialog content of the multi-part response includes multiple utterances (e.g., for each of the parts of the multi-part response), and the display content includes multiple display instructions that are executed when outputting the multi-part response.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

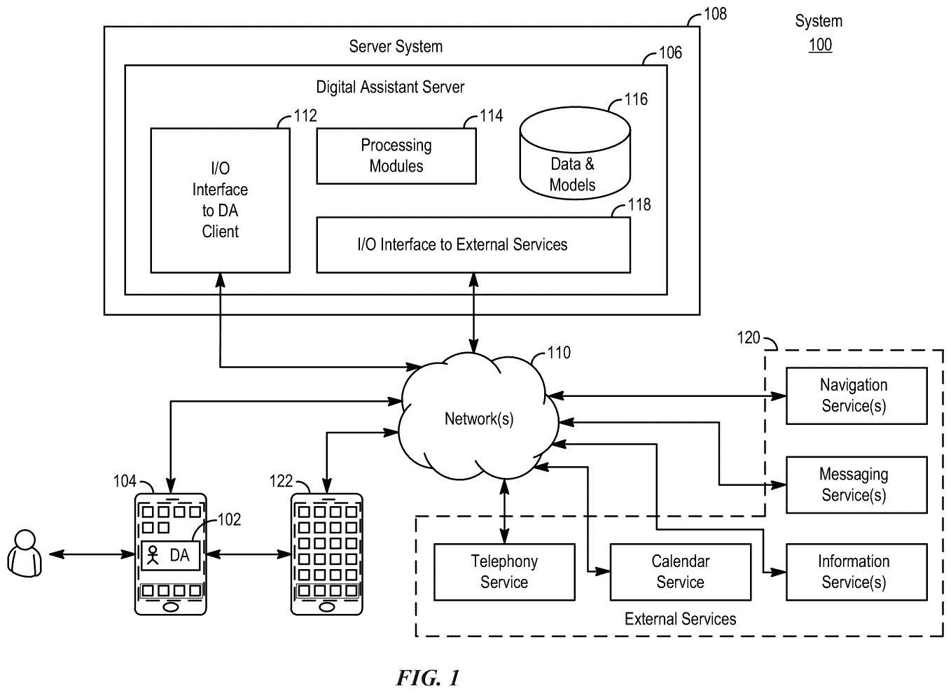

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, A Pls, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

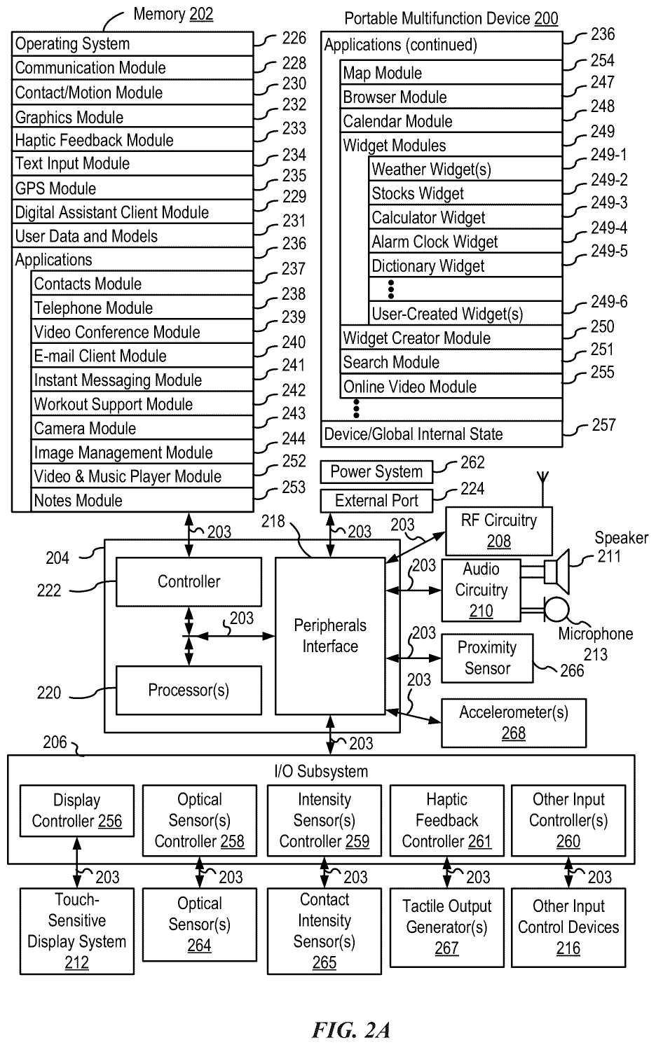

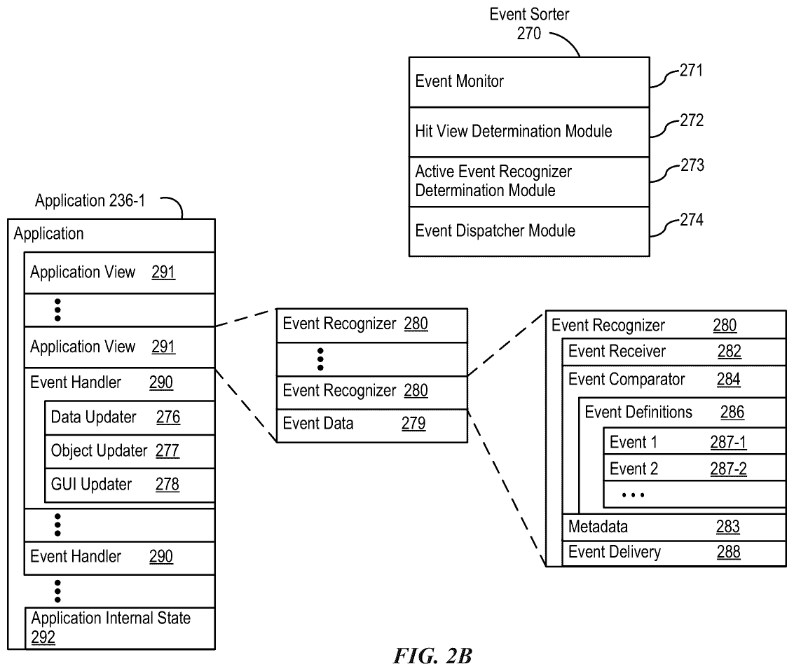

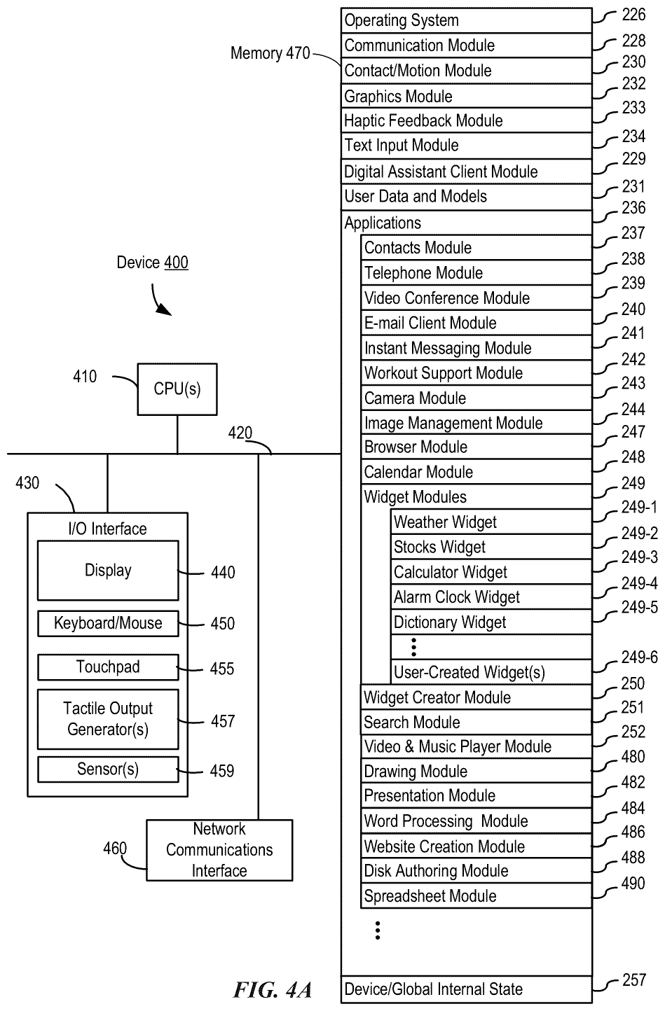

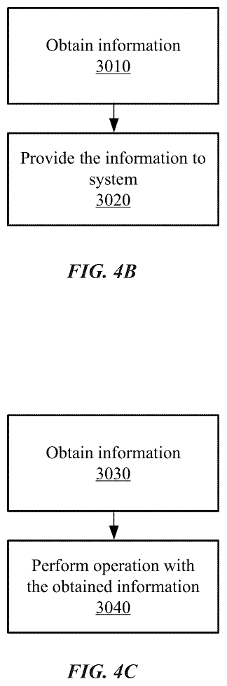

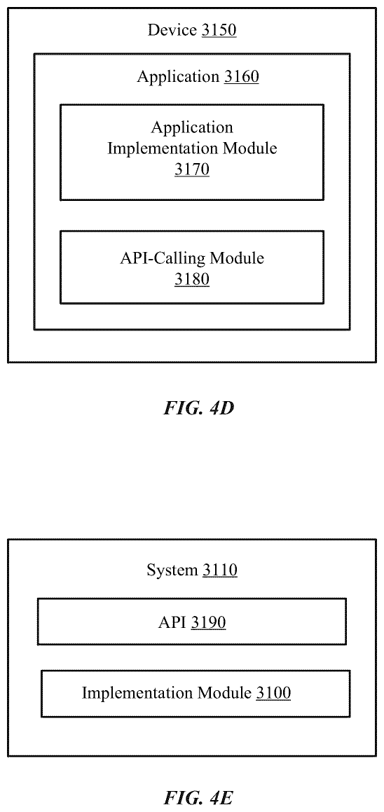

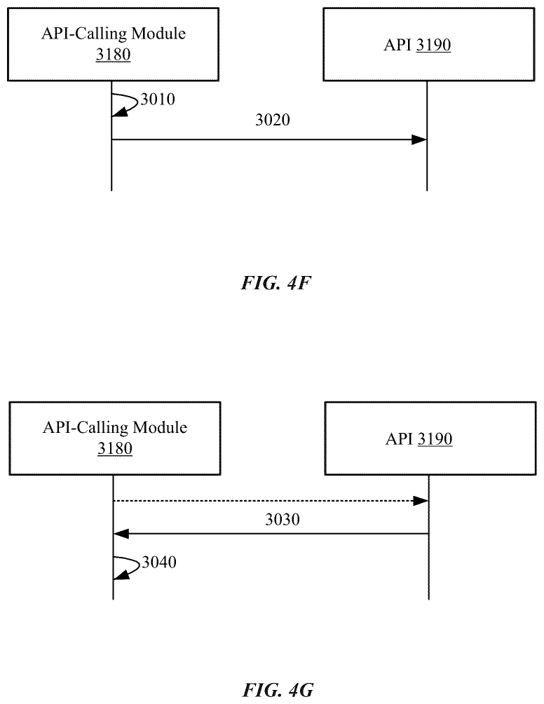

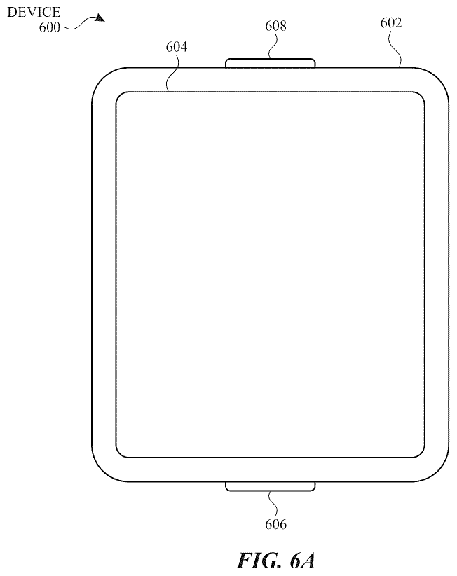

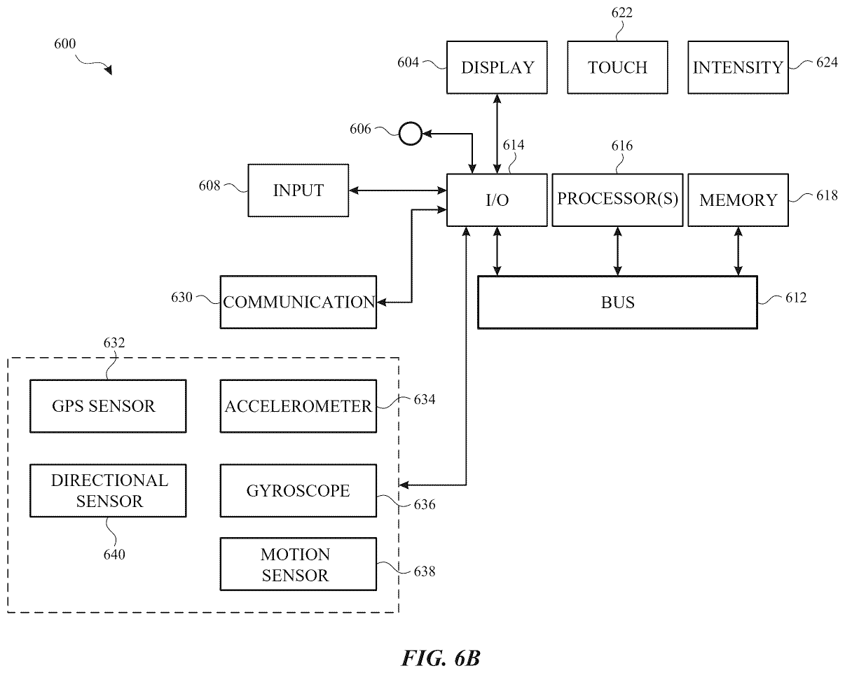

User device 104 can be any suitable electronic device. In some examples, user device 104 is a portable multifunctional device (e.g., device 200, described below with reference to FIG. 2A), a multifunctional device (e.g., device 400, described below with reference to FIG. 4A), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDM A), Bluetooth, Wi-Fi, voice over Internet Protocol (VoIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4A, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPU s) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDM A), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e mail (e.g., Internet message access protocol (IM A P) and/or post office protocol (POP)), instant messaging (e.g., extensible messaging and presence protocol (XM PP), Session Initiation Protocol for Instant Messaging and Presence Leveraging Extensions (SIM PLE), Instant Messaging and Presence Service (IMPS)), and/or Short Message Service (SMS), or any other suitable communication protocol, including communication protocols not yet developed as of the filing date of this document.

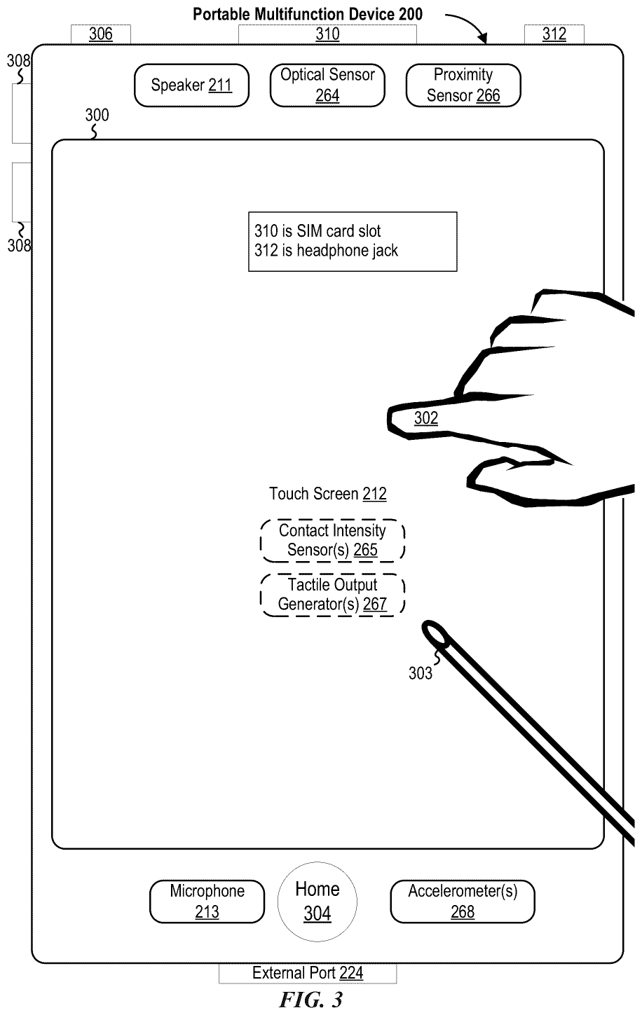

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A 1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (A C)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CM OS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4A) stores device/global internal state 257, as shown in FIGS. 2A and 4A. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts module 237, email client module 240, instant messaging (IM) module 241, browser module 247, and any other application that needs text input).

GPS module 235 determines the location of the device and provides this information for use in various applications (e.g., to telephone module 238 for use in location-based dialing; to camera module 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

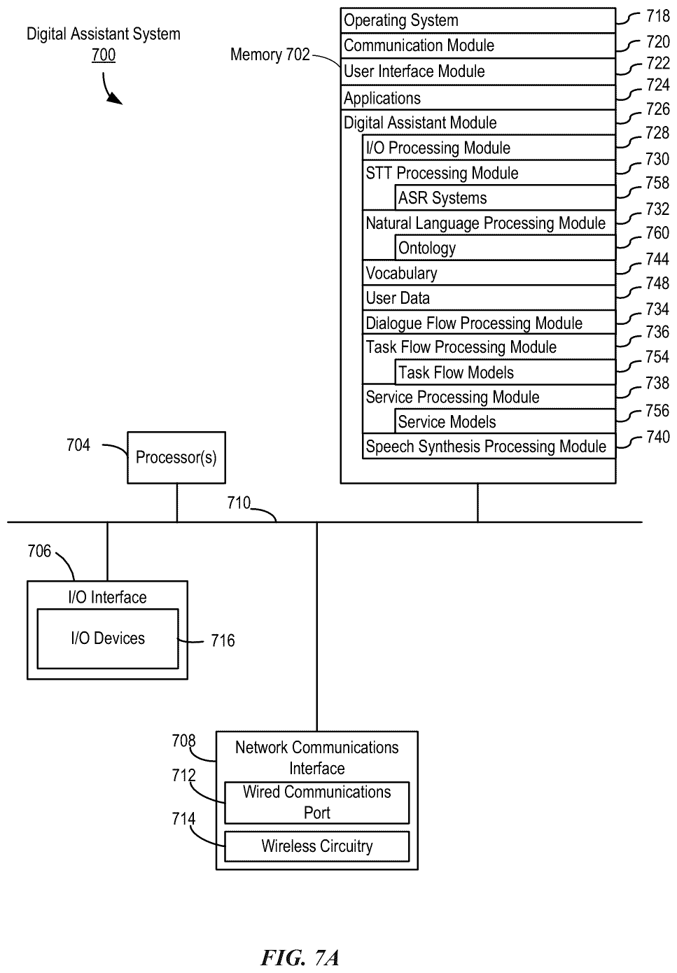

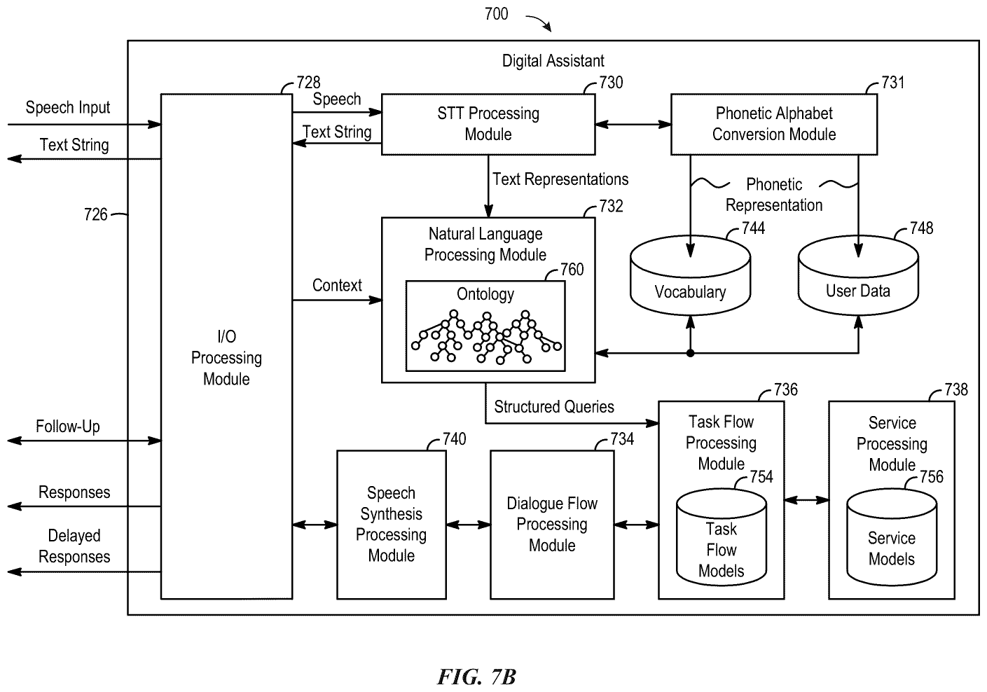

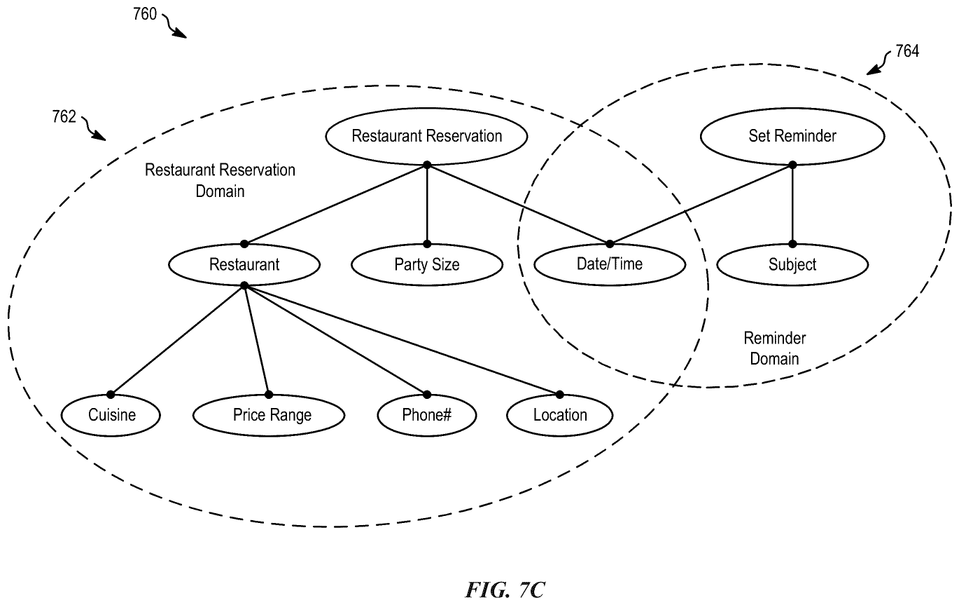

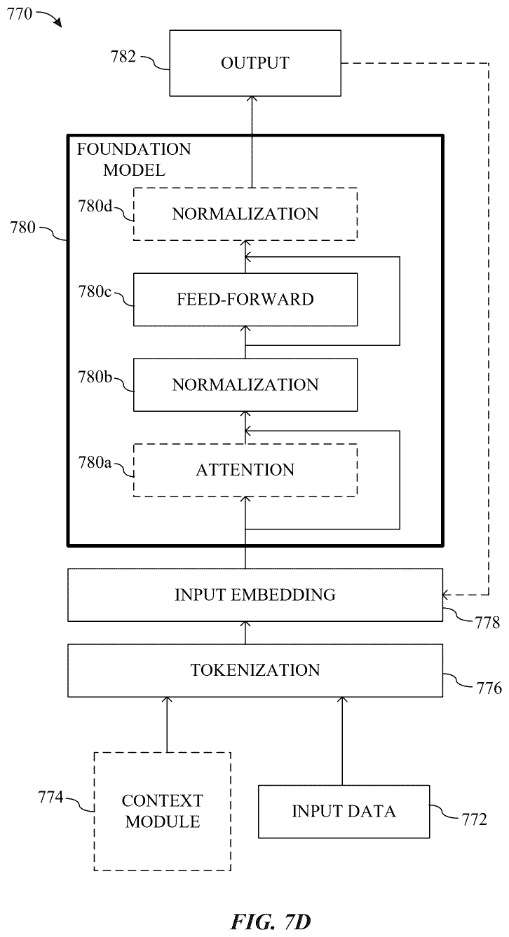

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
M ap module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 238, video conference module 239, e-mail client module 240, or IM module 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XM PP, SIM PLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XM PP, SIM PLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4A) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4A is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4A is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 4B, the method of FIG. 4C, and/or one or more other processes and/or methods described herein.

It should be recognized that application 3160 (shown in FIG. 4D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 4B and FIG. 4F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 4E) is an operating system hosted on device 3150. In some embodiments, the system (e.g., 3110 shown in FIG. 4E) is an external device (e.g., a server, a peripheral device, an accessory, and/or a personal computing device) that includes an operating system.

Referring to FIG. 4C and FIG. 4G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 4B and/or the method of FIG. 4C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 4B and/or the method of FIG. 4C by calling an application programming interface (API) (e.g., API 3190) provided by system 3110. In some embodiments, application 3160 performs at least a portion of the method of FIG. 4B and/or the method of FIG. 4C without calling API 3190.

In some embodiments, one or more steps of the method of FIG. 4B and/or the method of FIG. 4C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4D, device 3150 is illustrated. In some embodiments, device 3150 is a personal computing device, a smart phone, a smart watch, a fitness tracker, a head mounted display (HM D) device, a media device, a communal device, a speaker, a television, and/or a tablet. As illustrated in FIG. 4D, device 3150 includes application 3160 and an operating system (e.g., system 3110 shown in FIG. 4E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 4D and 4E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 4E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls A Pls from different providers such as a set of A Pls from an OS provider, another set of A Pls from a plug-in provider, and/or another set of A Pls from another provider (e.g., the provider of a software library) or creator of the another set of A Pls.

Examples of API 3190 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited A Pls (e.g., private A Pls or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some A Pls enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more A Pls (e.g., via multiple different A Pls). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

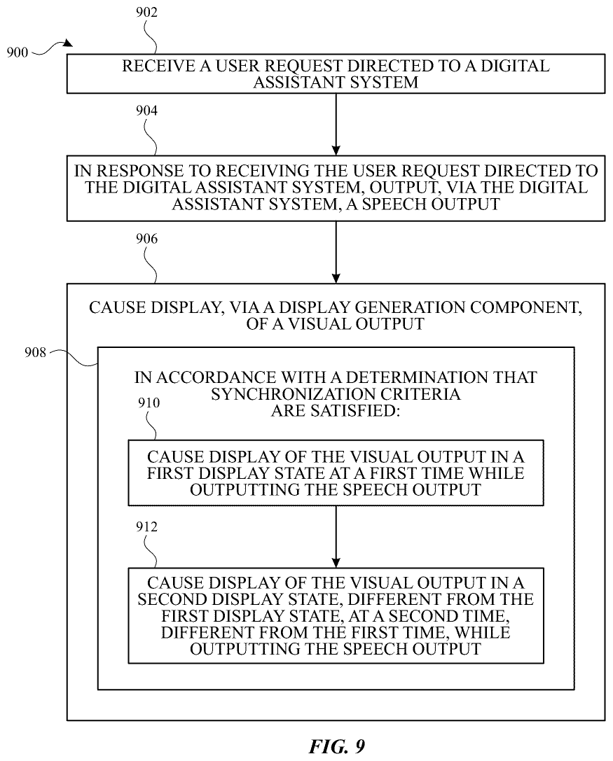

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 900 and/or 1000 (FIGS. 9 and/or 10A-10B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that can be implemented on, for example, portable multifunction device 200.

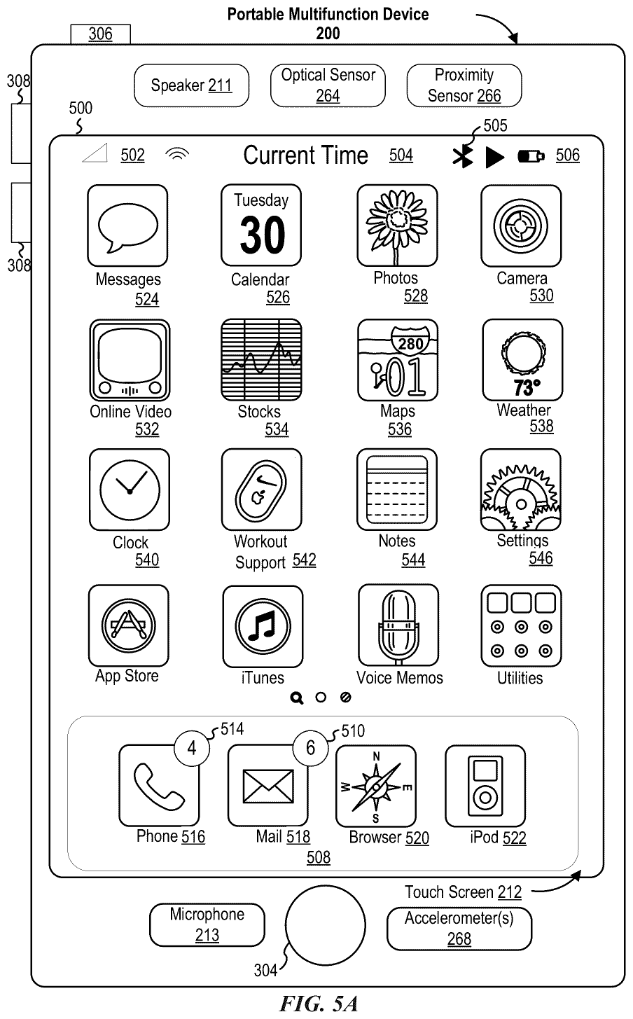

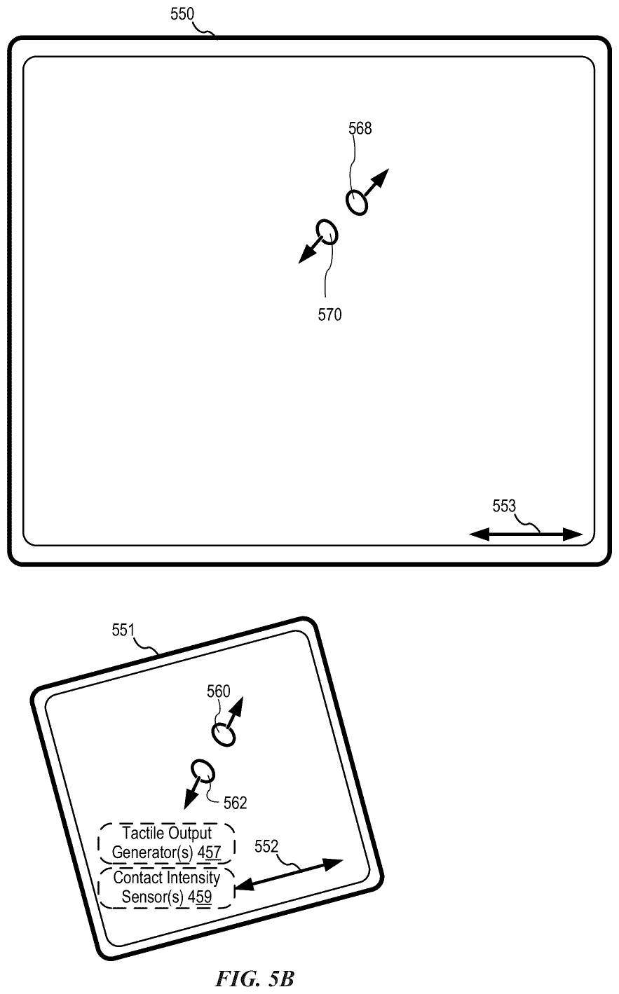

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4A) with a touch-sensitive surface 551 (e.g., a tablet or touchpad 455, FIG. 4A) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4A). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4A. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, 802A, 802B, and/or 802C (FIGS. 2A, 4A, 6A-6B, and 8A-8H). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4A or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600, 802A, 802B, and/or 802C) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, 802A, 802B, and/or 802C in FIGS. 2A, 4A, 6A-6B, respectively. In some examples, digital assistant system 700 represents the server portion of a digital assistant implementation, and can interact with the user through a client-side portion residing on a user device (e.g., devices 104, 200, 400, 600, 802A, 802B, and/or 802C).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4A, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of [symbol] and [symbol] . Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation [symbol] is ranked higher than [symbol] , because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation [symbol] is associated with the United States, whereas the candidate pronunciation [symbol] is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation [symbol] (associated with the United States) is ranked higher than the candidate pronunciation [symbol] (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes [symbol] corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes [symbol] corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the A Pls for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HM M) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

### 4. Foundation Model

FIG. 7D illustrates exemplary foundation system 770 including foundation model 780, according to various examples. In some examples, the blocks of foundation system 770 are combined, the order of the blocks is changed, and/or blocks of foundation system 770 are removed.

Foundation system 770 includes tokenization module 776, input embedding module 778, and foundation model 780 which use input data 772 and, optionally, context module 774 to train foundation model 780 to process input data 772 to determine output 782.

In some examples, the various components of digital assistant system 700 (e.g., digital assistant module 726, operating system (e.g., 226 or 718), and/or software applications (e.g., 236 and/or 724) installed on device 104, 200, 400, 600, 802A, 802B, 802C, and/or 1202) include and/or are implemented using generative artificial intelligence (AI) such as foundation model 780. In some examples, foundation model 780 include a subset of machine learning models that are trained to generate text, images, and/or other media based on sets of training data that include large amounts of a particular type of data. Foundation model 780 is then integrated into the components of digital assistant system 700 or otherwise available to digital assistant system 700, (e.g., digital assistant module 726, operating system (e.g., 226 or 718), software applications (e.g., 236 and/or 724) installed on device 104, 200, 400, 600, 802A, 802B, 802C, and/or 1202 and/or via an API) to provide text, images, and/or other media that digital assistant system 700 uses to determine tasks, perform tasks, and/or provide the outputs of tasks.

Foundation models are generally trained using large sets unlabeled data first and then later adapted to a specific task within the architecture of digital assistant system 700. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Generative AI models, such as foundation model 780, are trained on large quantities of data with self-supervised or semi-supervised learning to be adapted to a specific downstream task. For example, foundation model 780 is trained with large sets of different images and corresponding text or metadata to determine the description of newly captured image data as output 782. These descriptions can then be used by digital assistant system 700 to determine user intent, tasks, and/or other information that can be used to perform tasks. For example, generative AI models such as Midjourney, DALL-E, and stable diffusion are trained on large sets of images and are able to convert text to a generated image.

Large language models (LLM) are a type of foundation model that provide text output after being trained on large sets of input text data. As with other foundation models, LLMs can be trained in a self-supervised manner and thus the output of different LLM s trained on the same large set of input text can be different. These LLM s can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks. For example, GPT and LLaM A are exemplary large language models that process large amounts of input text and generates text that can be used by a digital assistant, a software application, and/or an operating system.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 780 (e.g., an LLM) has been fully trained, foundation model 780 can process input data 772 as discussed below to determine output 782 which may be used to further train foundation model 780 or can be processed by digital assistant system 700 to perform a task and/or provide an output to the user.

Specifically, input data 772 is received and provided to tokenization module 776 which converts input data 772 into a token and/or a series of tokens which can be processed by input embedding module 778 into a format that is understood by foundation model 780. Tokenization module 776 converts input data into a series of characters that has a specific semantic meaning to foundation model 780.

In some examples, tokenization module 776 tokenizes contextual data from context module 774 to add further information to input data 772 for processing by foundation model 780. For example, context module 774 can provide information related to input data 752 such as a location that input data 772 was received, a time that input data 772 was received, other data that was received contemporaneously with input data 772, and/or other contextual information that relates to input data 772. Tokenization module 776 can then tokenize this contextual data with input data 772 to be provided to foundation model 780.

After input data 772 has been tokenized, input data 772 is provided to input embedding module 778 to convert the tokens to a vector representation that can be processed by foundation model 780. In some examples, the vector representation includes information provided by context module 774. In some examples, the vector representation includes information determined from output 782. Accordingly, input embedding module 778 converts the various data provided as an input into a format that foundation model 780 can parse and process.

For example, when foundation model 780 is a large language model (LLM) tokenization module 776 converts input data 772 into text which is then converted into a vector representation by input embedding module 778 that can be processed by foundation model 780 to determine a response to input data 772 as output 782 or to determine a summary of input data 772 as output 782. As another example, when foundation model 780 is a model that has been trained to determine descriptions of images, input data 772 of images can be tokenized into characters and then converted into a vector representation by input embedding module 778 that is processed by foundation model 780 to determine a description of the images as output 782.

Foundation model 780 processes the received vector representation using a series of layers including, in some embodiments, attention layer 780a, normalization layer 780b, feed-forward layer 780c, and/or normalization layer 780d. In some examples, foundation model 780 includes additional layers similar to these layers to further process the vector representation. Accordingly, foundation model 780 can be customized based on the specific task that foundation model 780 has been trained to perform. Each of the layers of foundation model 780 perform a specific task to process the vector representation into output 782.

Attention layer 780a provides access to all portions of the vector representation at the same time, increasing the speed at which the vector representation can be processed and ensuring that the data is processed equally across the portions of the vector representation. Normalization layer 780b and normalization layer 780d scale the data that is being processed by foundation model 780 up or down based on the needs of the other layers of foundation model 780. This allows foundation model 780 to manipulate the data during processing as needed. Feed-forward layer 780c assigns weights to the data that is being processed and provides the data for further processing within foundation model 780. These layers work together to process the vector representation provided to foundation model 780 to determine the appropriate output 782.

For example, as discussed above, when foundation model 780 is a large language model (LLM) foundation model 780 processes input text to determine a summary and/or further follow-up text as output 782. As another example, as discussed above, when foundation model 780 is a model trained to determine descriptions of images, foundation model 780 processes input images to determine a description of the image and/or tasks that can be performed based on the content of the images as output 782.

In some examples, output 782 is further processed by digital assistant system 700 (e.g., digital assistant module 726, operating system (e.g., 226 or 718), and/or software applications (e.g., 236 and/or 724) installed on device 104, 200, 400, 600, 802A, 802B, and/or 802C) to provide an output or execute a task. For example, when output 782 is a sentence describing a task that digital assistant system 700 has performed, digital assistant system 700 can use the text to create a visual or audio output to be provided to a user. As another example, when output 782 is text that includes a function and a parameter for the function, digital assistant system 700 can perform a function call to execute the function with the provided parameter

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

5. Systems for Providing Multi-Part Responses with Display Content

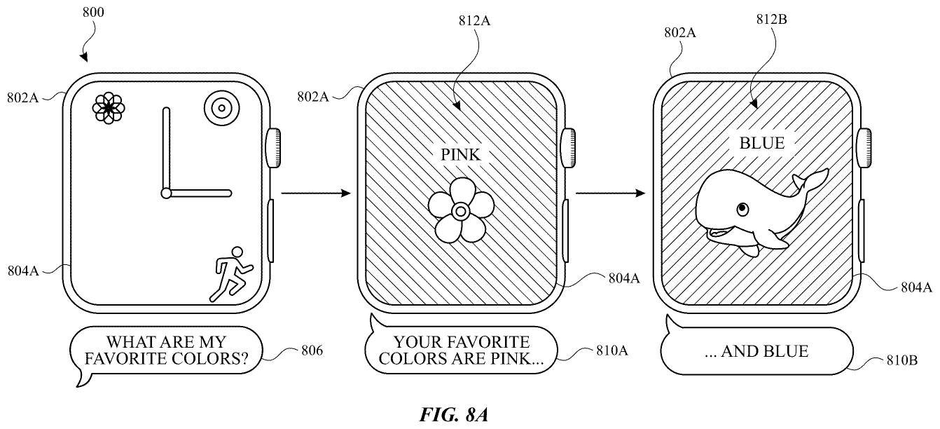

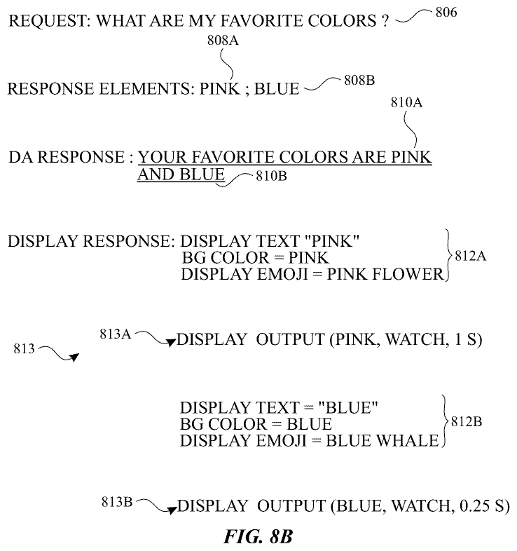

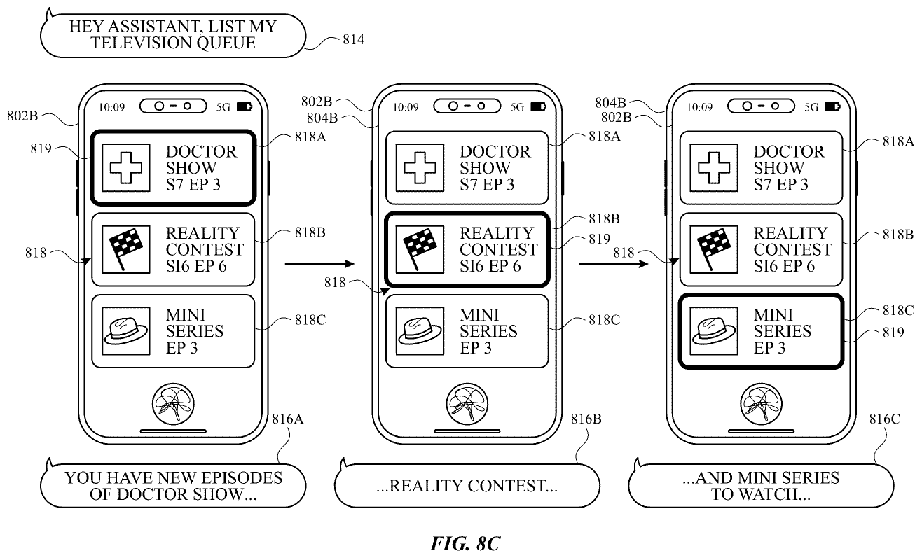

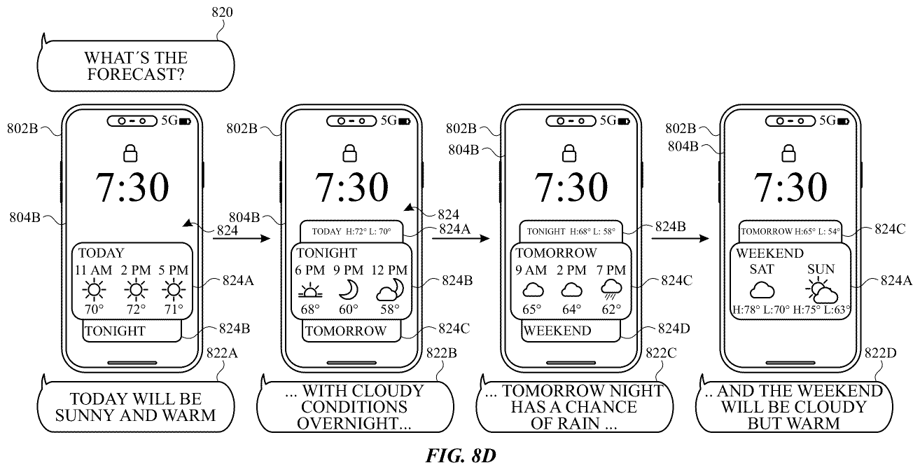

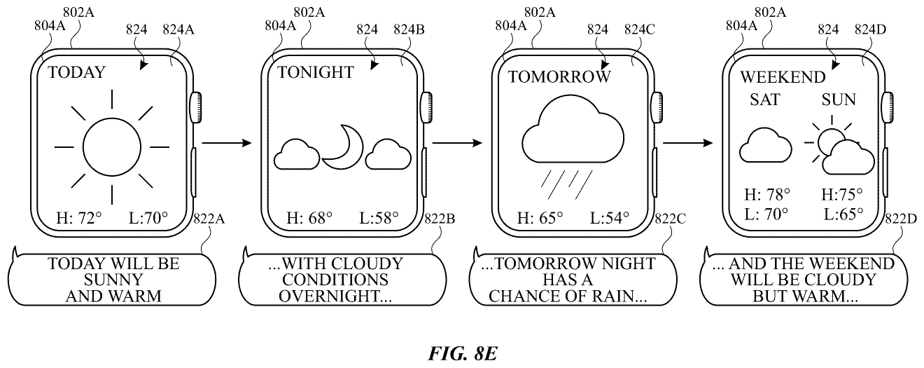

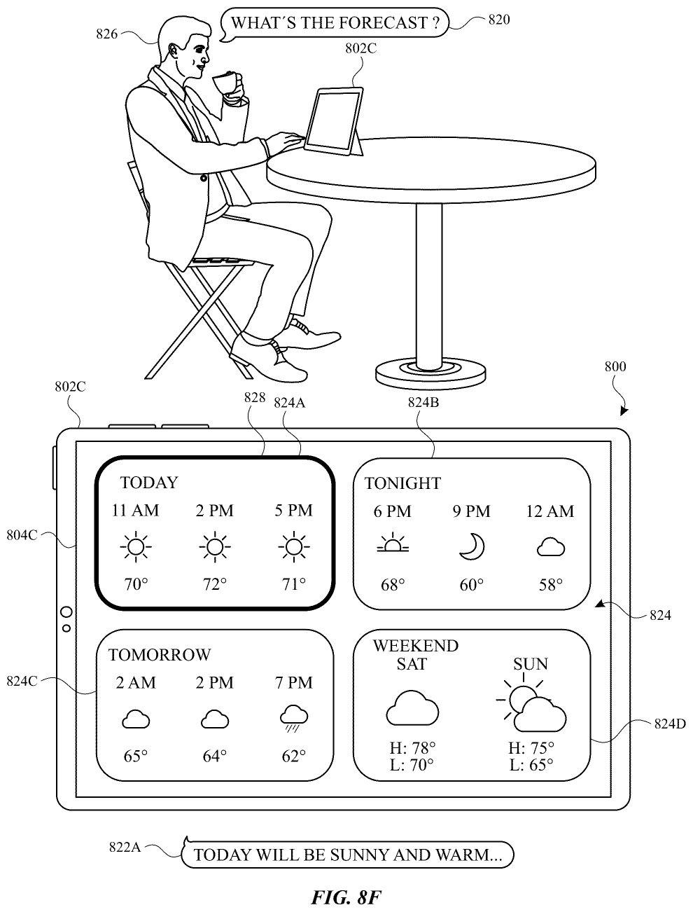

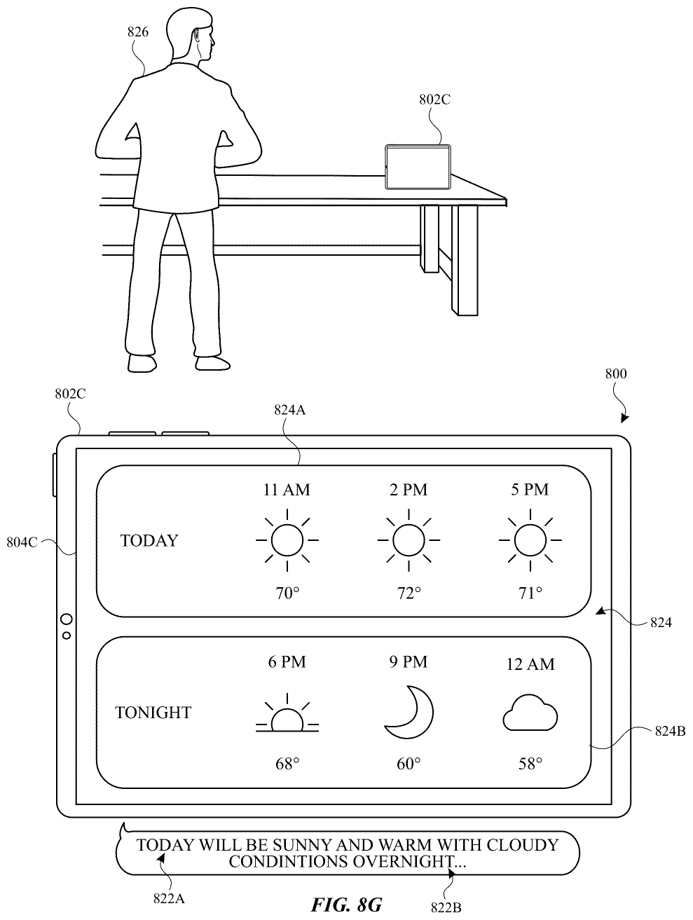

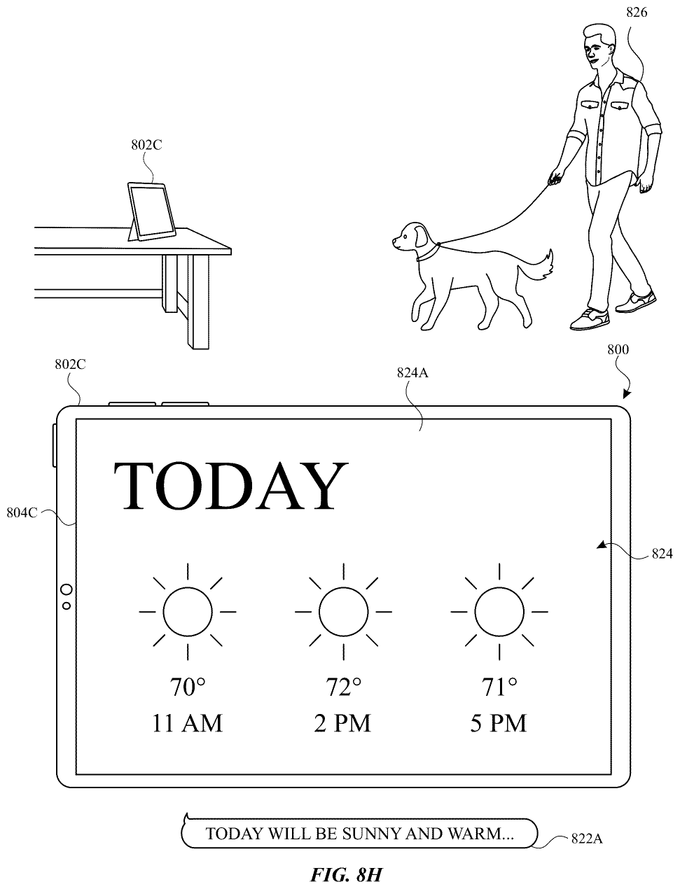

FIGS. 8A-8H illustrate system 800 for generating and synchronizing multi-part responses to user requests with display content, according to various examples. System 800 is implemented, for example, using one or more electronic devices (e.g., a mobile device, a personal computer, a communal device, a wearable electronic device, and/or a peripheral device) implementing a digital assistant (e.g., digital assistant system 700). In some examples, system 800 is implemented using a client-server system (e.g., system 100), and the functions of system 800 are divided up in any manner between the server (e.g., DA server 106) and a client device (e.g., 104, 802A, 802B, and/or 802C). In other examples, the functions of system 800 are divided up between the server and multiple client devices. Thus, while some functions of system 800 are described herein as being performed by particular devices of a client-server system, it will be appreciated that system 800 is not so limited. In other examples, system 800 is implemented using only a client device (e.g., 104, 802A, 802B, and/or 802C) or only multiple client devices. In system 800, some functions are, optionally, combined, the order of some functions is, optionally, changed, and some functions are, optionally, omitted. In some examples, additional functions may be performed in combination with the system 800.

At FIG. 8A, system 800 detects request 806, a spoken input asking, “What are my favorite colors?” As illustrated in FIG. 8A, system 800 may detect request 806 at device 802A, a smart watch device with a display 804A implementing system 800 (e.g., using a microphone included in the smart watch), and/or at another device in communication with device 802A, such as a companion mobile phone, smart home hub, tablet, and/or audio peripheral (e.g., headphones, earbuds, and/or speakers). In some embodiments, request 806 is a request directed to a digital assistant of system 800 (e.g., digital assistant system 700). For example, request 806 may be accompanied by a digital assistant trigger (e.g., a spoken trigger, such as “Hey assistant,” a button press, and/or a gesture, such as raising the smart watch device to speak into it) or provided during an ongoing digital assistant session, or based on a determination that request 806 relates to a task that the digital assistant of system 800 can assist in performing (e.g., a triggerless digital assistant interaction).

As illustrated in FIGS. 8A-8B, system 800 generates a multi-part response to request 806. With reference to FIG. 8B, the response to request 806 is a multi-part response that includes two response elements (e.g., subjects): the color pink (response element 808A) and the color blue (response element 808B) (e.g., the user's two favorite colors). In some embodiments, system 800 determines response elements to include in the response to request 806 based on user data and/or associated context, such as information from a previous digital assistant interaction or a shopping application where the user identified pink and blue as their favorite colors. For example, the response to request 806 is a digital assistant response, e.g., a response generated and provided to the user at least in part using the digital assistant of system 800.

In particular, system 800 generates spoken output 810, “Your favorite colors are pink and blue.” For example, spoken output 810 is audibly output by device 802A (e.g., using speakers included in the smart watch) and/or by another device in communication with device 802A as a synthetic speech output (e.g., generated using a text-to-speech service of the digital assistant of system 800) verbally responding to request 806. In some embodiments, system 800 (e.g., and/or the digital assistant system of system 800) generates spoken output 810 to include one (or more) words corresponding to response element 808A and one (or more) words corresponding to response element 808B. As illustrated in FIG. 8A, in response to request 806, system 800 first outputs spoken output 810A, “Your favorite colors are pink . . . ,” the portion of spoken output 810 corresponding to response element 808A, and subsequently outputs spoken output 810B, “ . . . and blue,” the portion of spoken output 810 corresponding to response element 808B.

Additionally, in response to request 806, system 800 generates visual output 812. With reference to FIG. 8B, system 800 generates display instructions 813 corresponding to the two response elements 808A and 808B. In some embodiments, display instructions 813 may include instructions to one or more applications or services to display outputs corresponding to the two response elements 808A and 808B. In some embodiments, display instructions 813 detailed display instructions that specify the information to include in visual output 812 and/or the way in which visual output 812 should be formatted. For example, display instructions 813 may include instructions for displaying the text “pink,” displaying a pink flower emoji, and displaying a pink background, corresponding to response element 808A, and/or instructions for displaying the text “blue,” displaying a blue whale emoji, and displaying a blue background, corresponding to response element 808B, as illustrated in FIG. 8A.

In some embodiments, display instructions 813 may include emphasis instructions for visual output 812. For example, emphasis instructions 813A and 813B may be actionable intent objects (e.g., for a display action) including response elements 808A and 808B as parameters, which system 800 (e.g., and/or the digital assistant system) can pass to an application or service to cause the application/service to display visual outputs 812A and 812B (e.g., using the application's own resources and capabilities to display content corresponding to response elements 808A and 808B). System 800 and/or the digital assistant system may pass additional context information to the application/service to use when displaying visual output 812A based on emphasis instruction 813A and/or visual output 812B based on emphasis instruction 813B, such as device context (e.g., indicating the form factor/device type of device 802A/display 804A, remaining battery life, user proximity, etc.), user settings/preferences (e.g., indicating a minimum font size, preferred language, etc.), and/or other relevant context, as discussed in further detail with respect to FIGS. 8E-8H.

In particular, as illustrated in FIG. 8A, in response to request 806, device 802A displays visual output 812A while outputting spoken output 810A, and device 802A displays visual output 812B while outputting spoken output 810B, such that visual output 812 is synchronized with spoken output 810. Visual output 812A and visual output 812B are displayed sequentially on display 804A, with visual output 812B fully replacing visual output 812A while outputting spoken output 810B. In some examples, system 800 may display a transition animation, such as fading, wiping, or morphing from visual output 812A to visual output 812B. For example, visual output 812 is displayed via display 804A by executing the display instructions (e.g., directly, for instance, using the digital assistant system) and/or providing the display instructions to applications or services of device 802A other than the digital assistant system to cause those agents to display visual output 812A and/or visual output 812B. Accordingly, visual output 812 is synchronized with the output of spoken output 810 as a “slide show” type display.

In some embodiments, system 800 causes the execution of display instructions 813 based on planned or estimated timing for spoken output 810. For example, system 800 determines that spoken output 810A should take one second to deliver and that spoken output 810B should take 0.25 seconds to deliver, and accordingly generates display instructions for visual output 812A (e.g., emphasis instruction 813A) with a one-second timer and generates display instructions for visual output 812B (e.g., emphasis instruction 813B) with a 0.25-second timer, e.g., as illustrated in FIG. 8B. In some embodiments, display instructions 813 additionally include transition instructions, such as instructions for presenting the transition from visual output 812A to visual output 812B, for instance, with particular transition timing (e.g., transitioning over the course of 0.1 second, transitioning as spoken output 810 gets to the word “and”) and/or a particular transition effect (e.g., fading, wiping, morphing, or the like).

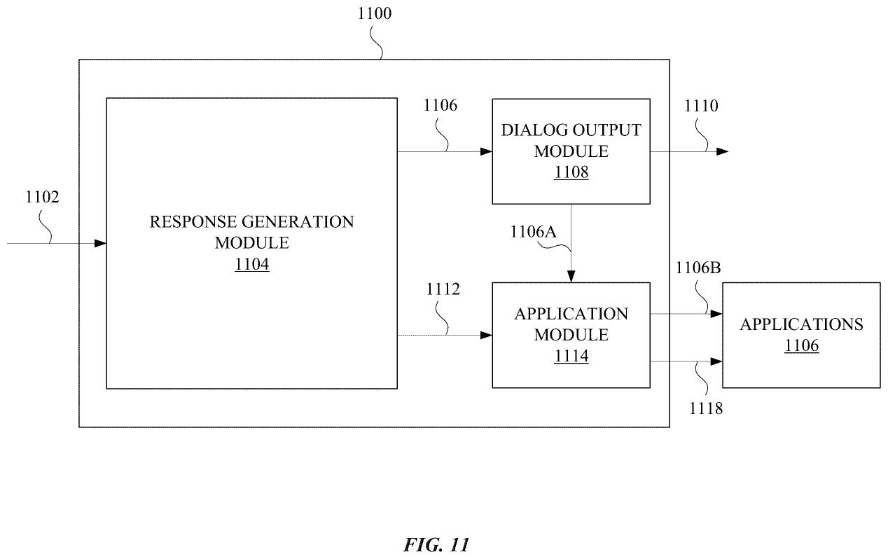

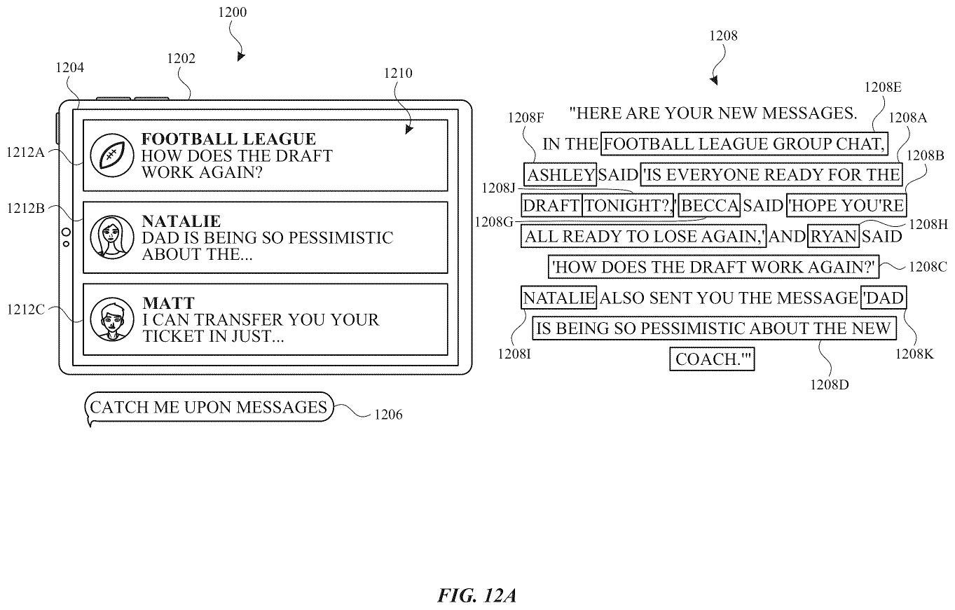

In some embodiments, system 800 embeds display instruction 813 into a representation of spoken output 810, e.g., a tokenized representation of spoken output 810 provided to the text-to-speech system for output, such that when the representation of spoken output 810 is converted to synthesized speech for output, the embedded instructions are executed. For example, system 800 embeds display instructions for visual output 812A (e.g., emphasis instruction 813A) into the representation of spoken output 810A and embeds display instructions for visual output 812B (e.g., emphasis instruction 813B) into the representation of spoken output 810B, such that the display of visual output 812A is triggered when (e.g., during, shortly before, and/or shortly after) outputting spoken output 810A and the display of visual output 812B is triggered when outputting spoken output 810B. For example, system 800 may embed emphasis instruction 813A with the word “Your” of spoken output 810, such that emphasis instruction 813A is passed to an application when the word “Your” of spoken output 810A is spoken, and may embed emphasis instruction 813B with the word “and” of spoken output 810, such that emphasis instruction 813B is passed to an application when the word “and” of spoken output 810B is spoken. In some embodiments, system 800 annotates spoken output 810 (e.g., with element identifiers for response elements 808A and 808B) as described below with respect to FIGS. 11-13.

At FIG. 8C, system 800 detects request 814, “Hey assistant, list my television queue,” at device 802B, a mobile phone device with display 804B implementing system 800. In response to request 814, system 800 generates a multi-part response including three response elements: a first episode in the user's television queue (e.g., an episode of a doctor show), a second episode in the user's television queue (e.g., an episode of a reality competition show), and a third episode in the user's television queue (e.g., an episode of a miniseries). For example, system 800 may identify the three response elements based on information obtained via the user's media streaming account(s) or application(s) about new, unwatched, saved, or queued episodes. In addition to identifying the response elements, system 800 may obtain information related to the response elements from the user's media streaming accounts/applications, such as the show names, episode names, episode numbers, release dates, thumbnail images, logos, user preferences, application deep links, and/or entity identifiers/pointers.

As illustrated in FIG. 8C, in response to request 814, system 800 outputs spoken output 816, “You have new episodes of Doctor Show, Reality Contest, and M ini Series to watch,” and visual output 818, including visual output 818A corresponding to the first episode in the user's television queue, visual output 818B corresponding to the second episode in the user's television queue, and visual output 818C corresponding to the third episode in the user's television queue. In some embodiments, system 800 may generate spoken output 816 and visual output 818 using the information obtained from the user's media streaming accounts/applications. For instance, system 800 may generate spoken output 816 to include show names (corresponding to the response elements) that are obtained from the accounts/applications, and/or cause display of visual output 818 including show thumbnails (corresponding to the response elements) that are obtained from the accounts/applications. In some embodiments, system 800 generates visual output 818 by instructing the media application(s) (e.g., that identified the corresponding response elements) to display visual output 818A, visual output 818B, and/or visual output 818C. For example, system 800 may provide the media application(s) with detailed instructions (e.g., specifying information and/or formatting) for the display of visual output 818. For example, system 800 may provide the media application(s) with the response elements and/or emphasis instructions for the response elements to allow the media application(s) to display visual outputs corresponding to each element (e.g., as further described with respect to FIGS. 11-13, below).

In particular, while outputting spoken output 816A, “You have new episodes of Doctor Show . . . ” corresponding to the episode of the doctor show, visual output 818 is displayed with border element 819 around visual output 818A, visually emphasizing the element relative to visual outputs 818B and 818C. For example, visual output 818A may also be emphasized by highlighting the element, displaying it at a larger size, and/or displaying it with higher contrast or opacity in comparison to visual outputs 818B and 818C, which are not highlighted, displayed at a smaller size, and/or displayed with lower contrast or opacity (e.g., faded or grayed out). Then, while outputting spoken output 816B, “ . . . . Reality Contest . . . ” corresponding to the episode of the reality competition, visual output is displayed with border element 819 around visual output 818B, visually emphasizing the element relative to visual outputs 818A and 818C. Finally, while outputting spoken output 816C, “and Mini Series to watch” corresponding to the episode of the miniseries, visual output is displayed with border element 819 around visual output 818C, visually emphasizing the element relative to visual outputs 818A and 818B. For example, as discussed with respect to FIG. 8B, system 800 may generate display instructions corresponding to the three different emphasis states (e.g., instructing to emphasize visual outputs 818A, 818B, and 818C one at a time) and coordinate the execution of those display instructions according to the expected output timing of spoken output 816A, 816B, and 816C and/or by embedding the display instructions corresponding to the three different emphasis states into a representation of spoken output 816 for delivery. Accordingly, even though elements of visual output 818 corresponding to different response elements are displayed at the same time, visual output 818 is synchronized with spoken output 816 by displaying visual output 818 with “follow-along” emphasis.

At FIG. 8D, system 800 receives a request to provide a weather forecast. For example, the request to provide a weather forecast may include request 820 (“What's the forecast?”), e.g., a spoken, digital assistant request detected at device 802A and/or another connected device, such as discussed with respect to FIGS. 8A-8C. As another example, the request to provide a weather forecast may include a request generated (e.g., by the digital assistant system) in response to a user input, such as a user input requesting that the digital assistant automatically deliver a weather report at 7:30 AM on weekdays. In response to request 820, system 800 generates a multi-part response including four response elements: today's daytime weather forecast, today's nighttime weather forecast, tomorrow's forecast, and a longer-term forecast (e.g., for the upcoming weekend). For example, system 800 may identify the four response elements based on the settings the automatic weather report, and system 800 may obtain information (e.g., times, temperatures, weather conditions, etc.) related to the response elements from a weather service or application.

FIG. 8D illustrates providing the multi-part response to the request to provide the weather forecast (e.g., including the four response elements) using device 802B (e.g., a mobile phone device). As illustrated in FIG. 8D, in response to the request to provide the weather forecast, device 802B (e.g., and/or another connected device) outputs spoken output 822, “Today will be sunny and warm with cloudy conditions overnight. Tomorrow night has a chance of rain, and the weekend will be cloudy but warm,” including utterances relating to each of the four response elements. Additionally, system 800 outputs visual output 824, which includes visual output 824A corresponding to today's daytime weather forecast, visual output 824B corresponding to today's nighttime weather forecast, visual output 824C corresponding to tomorrow's forecast, and visual output 824D, corresponding to the longer-term forecast for the upcoming weekend. In some embodiments, system 800 generates visual output 824 by instructing the weather application to display visual outputs 824A, 824B, 824C, and/or 824D. For example, system 800 may provide the weather application with detailed instructions (e.g., specifying information and/or formatting) for the display of visual output 824 and/or provide the weather applications with the response elements and/or emphasis instructions for the response elements to allow the weather application to display visual outputs corresponding to each element.

In particular, while system 800 outputs spoken output 822A, “Today will be sunny and warm . . . ” corresponding to today's daytime weather forecast, device 802B displays visual output 824A and visual output 824B. As illustrated in FIG. 8D, visual output 824A, which corresponds to the same response element as spoken output 822A, is fully displayed, including a detailed hourly forecast, at a first position near the center of display 804B. Visual output 824B, which corresponds to the next response element, is only partially displayed, for instance, appearing below and under visual output 824A, providing an indication of the next response element while remaining visually de-emphasized compared to visual output 824A.

Subsequently, while system 800 outputs spoken output 822B, “ . . . with cloudy conditions overnight . . . ” corresponding to today's nighttime weather forecast, device 802B fully displays visual output 824B (corresponding to the same response element as the spoken output), with a detailed hourly forecast, at the first position previously occupied by visual output 824A. Additionally, device 802B partially displays visual output 824C, corresponding to the next response element, as visual output 824B was previously displayed, and partially displays visual output 824A above and behind visual output 824B, providing indications of the previous and next response elements while remaining visually de-emphasized compared to visual output 824B. For example, system 800 may display an animation of visual output 824A moving up and receding to the back, visual output 824B moving up and forward (e.g., into focus), and visual output 824C appearing behind and below visual output 824C.

As illustrated in FIG. 8D, device 802B then updates visual output 824 to fully display visual output 824C while outputting spoken output 822C, “Tomorrow night has a chance of rain,” both corresponding to tomorrow's forecast, and to visually de-emphasize visual output 824B and visual output 824D (e.g., and ceasing to display visual output 824A) as previously described. For example, system 800 may display an animation as described above, e.g., “scrolling” the visual outputs up to focus visual output 824C. Finally, device 802B updates visual output 824 to fully display visual output 824D while outputting spoken output 822D, “and the weekend will be cloudy but warm,” both corresponding to the longer-term forecast, and to visually de-emphasize visual output 824C (e.g., without displaying visual outputs 824A or 824B). For example, as discussed with respect to FIG. 8B, system 800 may generate display instructions corresponding to the four different visual output states (e.g., scrolling through visual outputs 824A, 824B, 824C, and 824D to emphasize or focus one at a time while deemphasizing any others that are displayed) and coordinate the execution of those display instructions according to the expected output timing of spoken output 822A, 822B, and 822C and/or by embedding the display instructions corresponding to the three different emphasis states into a representation of spoken output 822 for delivery. Accordingly, even though some elements of visual output 824 corresponding to different response elements are displayed simultaneously, visual output 824 is synchronized with spoken output 822 by “scrolling” through the elements visual output 824 as the corresponding elements of spoken output 822 are output.

FIGS. 8E-8H illustrate synchronizing the spoken output and visual output of a multi-part response in different manners based on different response contexts. For example, depending on the response context, a multi-part response may be synchronized by updating the entire visual output for each part of the multi-part spoken output (e.g., as described with respect to FIG. 8A) or by partially updating the visual output for each part of the multi-part spoken output (e.g., as described with respect to FIG. 8C and/or FIG. 8D). For example, depending on the response context, a visual output may be updated at different times during the spoken output and/or different numbers of times during the spoken output. For example, depending on the response context, a visual output corresponding to a given response element may be displayed in different ways, e.g., with different amounts of detail, layouts, text sizes, graphics, etc.

FIG. 8E illustrates providing the multi-part response to the request to provide the weather forecast (e.g., including the four response elements for today's daytime forecast, today's nighttime forecast, tomorrow's forecast, and the weekend forecast) in a response context that includes using device 802A and display 804A. Based on the response context of using device 802A/display 804B, which have a more compact (e.g., smaller) form factor than device 802B and display 804B, system 800 synchronizes the output of visual output 824 with spoken output 822 by displaying the elements one at a time (e.g., a “slide show” synchronization, as described with respect to FIG. 8A), rather than synchronizing the output of visual output 824 with spoken output 822 to include displaying multiple elements at the same time (e.g., the “scrolling” synchronization described with respect to FIG. 8D). For example, updating visual output 824 to display one response element at a time improves the legibility of each element's contents on the smaller display 804A. Additionally, in some embodiments, visual outputs 824A, 824B, 824C, and 824D are formatted differently and/or present the information related to the corresponding response elements differently (e.g., including the high and low temperature for the entire corresponding time range instead of the hourly forecasts described with respect to FIG. 8D) when responding via device 802A than when responding via device 802B.

In some embodiments, system 800 specifies the manner of synchronization (e.g., whether to synchronize visual outputs 824A, 824B, 824C, and 824D using the “slide show” synchronization, “scrolling” synchronization, and/or “follow along” synchronization as described with respect to FIG. 8C), format, and/or information to include in the generated display instructions. In some embodiments, system 800 passes the form factor context information (and/or other relevant context information) to the weather application, allowing the weather application to select the manner of synchronization, format, and/or information to include when outputting visual output 824.

FIG. 8F illustrates providing the multi-part response to the request to provide the weather forecast (e.g., including the four response elements for today's daytime forecast, today's nighttime forecast, tomorrow's forecast, and the weekend forecast) in a response context that includes using device 802C, a tablet computing device with display 804C, which is a larger form factor device than device 802A and device 802B. The response context also includes the proximity of user 826, who, as illustrated in FIG. 8F, is physically close to device 802C, sitting directly in front of display 804C when making request 820 (“What's the forecast?”) and receiving the response. In some embodiments, system 800 determines the proximity of user 826 using one or more cameras, depth sensors, motion sensors, and/or proxy devices (e.g., detecting the proximity of a wearable or portable device of user 826, such as a smart watch device). In some embodiments, the distance of user 826 to device 802C in FIG. 8F may fall within a first threshold range (e.g., less than two feet, less than one meter, less than 18 inches, etc.) considered to be “close” proximity for device 802C. In some embodiments, the first threshold range may be a predetermined range approximately corresponding to distances “within arm's reach,” for instance, such that a user within the first threshold distance range from the device could interact with its touch-sensitive surface.

Based on the response context of using device 802C/display 804C and/or of user 826 being in close proximity to user 826, at FIG. 8F, system 800 synchronizes the output of visual outputs 824A-824D with spoken output 822 using the “follow along” synchronization described with respect to FIG. 8C. In particular, as illustrated in FIG. 8F, while system 800 outputs spoken output 822A, “Today will be sunny and warm . . . ” corresponding to today's daytime weather forecast, device 802C displays visual outputs 824A, 824B, 824C, and 824D, and displays visual output 824A (corresponding to today's weather forecast) with border element 828, emphasizing visual output 824A relative to visual outputs 824B, 824C, and 824D (corresponding to the other response elements). System 800 then updates visual output 824 to display border element 828 around visual output 824B while outputting spoken output 822B (“ . . . with cloudy conditions overnight . . . ”), around visual output 824C while outputting spoken output 822C (“ . . . . Tomorrow night has a chance of rain . . . ”), and finally around visual output 824D while outputting spoken output 822D (“ . . . and the weekend will be cloudy but warm.”).

Alternatively, in some embodiments, based on the response context of using device 802C/display 804C and/or of user 826 being in close proximity to user 826 at FIG. 8F, system 800 may not synchronize the output of visual outputs 824A-824D with spoken output 822. For example, system 800 may display visual outputs 824A-824D as illustrated in FIG. 8F, but forego displaying and updating border element 828 to change the display state of visual output 824.

FIG. 8G illustrates providing the multi-part response to the request to provide the weather forecast (e.g., including the four response elements for today's daytime forecast, today's nighttime forecast, tomorrow's forecast, and the weekend forecast) in a response context that includes using device 802C/display 804C and the proximity of user 826. At FIG. 8G, user 826 is physically further from device 802C than illustrated in FIG. 8F, for example, viewing display 804C from across a countertop. In some embodiments, the distance of user 826 to device 802C in FIG. 8G falls within a second threshold range (e.g., two to five feet, 1-2.5 meters, 18-50 inches, etc.) considered to be “moderate” proximity for device 802C.

Based on the response context of using device 802C/display 804C and/or of user 826 being in moderate proximity to device 802C, at FIG. 8G, system 800 synchronizes the output of visual output 824 with spoken output 822 using the “slideshow” synchronization described with respect to FIG. 8A. In particular, as illustrated in FIG. 8G, system 800 displays visual output 824A (corresponding to today's weather forecast) and visual output 824B (corresponding to this evening's weather forecast) while outputting both spoken output 822A and visual output 824B. System 800 then updates visual output 824 to display visual output 824C (corresponding to tomorrow's weather forecast) and visual output 824D (corresponding to the weekend's weather forecast). Accordingly, in some embodiments, system 800 may update visual output 824 twice while outputting spoken output 822 rather than four times (e.g., as described with respect to FIGS. 8D-8E and 8H). By only displaying two response elements at a time, the legibility of each element is improved when viewing from a moderate distance.

In some embodiments, system 800 synchronize the output of visual output 824 with spoken output 822 using a combination of synchronization techniques. For example, system 800 may display visual output 824A and visual output 824B at the same time as illustrated in FIG. 8G, and successively emphasize visual output 824A while outputting spoken output 822A and emphasize visual output 824B while outputting spoken output 822B (e.g., similarly to FIGS. 8C and 8E). As another example, system 800 may display visual output 824A and visual output 824B at the same time, as illustrated in FIG. 8G, while outputting spoken output 822A, then stop displaying visual output 824A, display visual output 824B in the position previously occupied by visual output 824A, and display visual output 824C in the position previously occupied by visual output 824B while outputting spoken output 822B (e.g., similarly to FIG. 8D).

FIG. 8H illustrates providing the multi-part response to the request to provide the weather forecast (e.g., including the four response elements for today's daytime forecast, today's nighttime forecast, tomorrow's forecast, and the weekend forecast) in a response context that includes using device 802C/display 804C and the proximity of user 826. At FIG. 8G, user 826 is physically further from device 802C than illustrated in FIG. 8G, for example, viewing display 804C from across a room. In some embodiments, the distance of user 826 to device 802C in FIG. 8H falls within a third threshold range (e.g., over five feet, over 2.5 meters, over 50 inches, etc.) considered to be “low” proximity for device 802C. In some embodiments, system 800 may use more, fewer, or different threshold distances ranges than described with respect to FIGS. 8F-8H. For example, the threshold ranges may differ based on device form factor (e.g., defining less than one foot as “close” proximity and over one foot as “low” proximity for device 802B), user settings (e.g., accessibility settings for display content), and/or response contents (e.g., defining a lower range for “close” proximity for detailed visual outputs than for simple visual outputs).

Based on the response context of using device 802C/display 804C and/or of user 826 being in low proximity to device 802C, at FIG. 8H, system 800 synchronizes the output of visual output 824 with spoken output 822 using the “slideshow” synchronization described with respect to FIG. 8A. In particular, as illustrated in FIG. 8H, system 800 displays visual output 824A as a full-screen output on display 804C while outputting spoken output 822A. System 800 then updates visual output 824 to display visual output 824B as a full-screen output on display 804C while outputting spoken output 822B, then to display visual output 824C as a full-screen output on display 804C while outputting spoken output 822C, and finally to display visual output 824D as a full-screen output on display 804C while outputting spoken output 822D.

The systems and operations described above with reference to FIGS. 8A-8H are optionally implemented by components depicted in FIGS. 1-4A, 6A-6B, and 7A-7C. For example, the operations of system 800 may be implemented by one or more electronic devices (e.g., 104, 122, 200, 400, 600, 802A, 802B, 802C) implementing system 700, such as a mobile phone, tablet computer, personal computer, smart home/hub device, automobile interface, wearable device (e.g., an HM D), and/or peripheral device (e.g., speakers, headphones, external displays, etc.). It would be clear to a person having ordinary skill in the art how other processes are implemented based on the components depicted in FIGS. 1-4A, 6A-B, and 7A-7C.

FIG. 9 is a flow diagram illustrating method 900 for synchronizing multi-part responses to user requests with display content, in accordance with some embodiments. M ethod 900 may be performed using one or more electronic devices (e.g., device 104, device 200, device 600, device 802A, device 802B, device 802C) with one or more processors, memory, and display generation components (e.g., 804). In some embodiments, method 900 is performed using a client-server system, with the operations of method 900 divided up in any manner between the client device(s) (e.g., 104, 200, 600, 802A, 802B, 802C) and the server. Some operations in method 900 are, optionally, combined, the orders of some operations are, optionally, changed, and some operations are, optionally, omitted.

The system implementing method 900 (e.g., 802A, 802B, and/or 802C) receives (902) (e.g., via one or more input devices, such as a microphone, touch-sensitive surface, button, keyboard, stylus, and/or sensor) a user request directed to a digital assistant system (e.g., 806, 814, and/or 820). In some embodiments, the user request includes a natural-language input, such as a speech or text input, e.g., “What are my favorite colors?,” “Hey Assistant, what shows do I have?,” “Assistant, give me a weather report,” or “Who are the members of Rock Band?” In some embodiments, the user request includes another input corresponding to a request, such as a selection of a suggestion affordance (e.g., “Tap to learn more about Rock Band”) or a request to set up an automated feature (e.g., setting up a digital assistant to provide a daily weather report). In some embodiments, the user request includes a trigger, such as a digital assistant trigger (e.g., a phrase such as “Hey Assistant” or “Assistant,” a button press, a user interface input, or a gaze input at a digital assistant user interface object) or an asynchronous trigger (e.g., a request to the digital assistant to provide a response at a certain time or under other conditions).

In response to receiving the user request directed to the digital assistant system, the system implementing method 900 outputs (904), via the digital assistant system, (e.g., via one or more audio output devices) a speech output (e.g., 810, 816, and/or 822). For example, the speech output includes a response to the user request, such as “Your favorite colors are pink and blue,” “You have new episodes of Doctor Show, Reality Contest, and Miniseries available to watch,” “Rock Band has four members: John, Paul, George, and Ringo,” “Today, it's going to be sunny and warm. There's a chance of rain tomorrow night, but the weekend should have clear skies.” In some embodiments, the speech output is output as synthesized speech, e.g., using a text-to-speech system to convert a representation of the speech output (e.g., a textual, phonemic, and/or tokenized representation) into audible speech. In some embodiments, the speech output includes a natural language utterance, such as generative or template-based speech.

The system implementing method 900 causes display (906), via a display generation component, of a visual output (e.g., 812, 818, and/or 824) (e.g., a user interface including text, icons, pictures, video, animation, and/or other graphical elements). Causing the display (906) of the visual output includes, in accordance with a determination that synchronization criteria are satisfied (908), causing display (910) of the visual output in a first display state at a first time while outputting the speech output (e.g., the display states illustrated in FIGS. 8A and 8C-8H while outputting 810A, 816A, and 822A). For example, the first time is an actual or expected time of delivery of a first utterance (e.g., portion) of the speech output, where the first utterance corresponds to the first state of the visual output. For example, causing display of the visual output in a first display state includes displaying a pink background with the text “pink” while outputting the speech “pink,” highlighting one episode thumbnail while outputting the speech “You have new episodes of Doctor Show,” displaying a photo and text blurb about John while outputting the speech “John,” or focusing a forecast widget for today while outputting the speech “Today will be sunny and warm.” In some embodiments, causing display of the visual output in the first display state includes displaying at least one visual output component corresponding to a first portion of the speech output (e.g., as illustrated in FIGS. 8A and 8C-8H). In some embodiments, causing display of the visual output in the first display state includes visually emphasizing/focusing the at least one visual output component corresponding to the first portion of the speech output in comparison to at least one other visual output component that does not correspond to the first portion of the speech output (e.g., as illustrated in FIGS. 8C-8D and 8F-8G).

Causing the display (906) of the visual output further includes, in accordance with a determination that synchronization criteria are satisfied (908), causing display (912) of the visual output in a second display state, different from the first state, at a second time, different from the first time, while outputting the speech output (e.g., the display states illustrated in FIGS. 8A and 8C-8E while outputting 810B, 816B, and 822B). For example, the second time is an actual or expected time of delivery of a second utterance (e.g., portion) of the speech output, where the second utterance corresponds to the second state of the visual output. For example, causing display of the visual output in a second display state includes displaying a blue background with the text “blue” while outputting the speech “blue,” emphasizing another episode thumbnail while outputting the speech “Reality Contest,” displaying a photo and text blurb about Paul while outputting the speech “Paul,” or focusing a forecast widget for the upcoming weekend while outputting the speech “Tomorrow night has a chance of rain.” In some embodiments, causing display of the visual output in the second display state includes displaying at least one visual output component corresponding to a second portion of the speech output (e.g., as illustrated in FIGS. 8A and 8C-8D). In some embodiments, causing display of the visual output in the second display state includes visually emphasizing/focusing the at least one visual output component corresponding to the second portion of the speech output in comparison to at least one other visual output component that does not correspond to the second portion of the speech output (e.g., as illustrated in FIGS. 8C-8D).

In some embodiments, the speech output includes a first utterance associated with (e.g., corresponding to, relating to, and/or representing) a first subject (e.g., “pink” (810A), “John,” “Doctor Show” (816A), “Today will be sunny and warm” (822A)) and a second utterance associated with a second subject that is different from the first subject (e.g., “blue” (810B), “Paul,” “Reality Contest” (816B), “with cloudy conditions overnight” (822B)), e.g., as described with respect to FIGS. 8A-8E and 8G). In some embodiments, the first utterance is output (or scheduled for output) at or near the first time, e.g., the first utterance is output while the visual output is displayed in the first state; and the second utterance is (or scheduled for output) at or near the second time, e.g., the second utterance is output while the visual output is displayed in the second state. In some embodiments, causing display of the visual output in the first display state includes causing display of first content associated with (e.g., corresponding to, relating to, and/or representing) the first subject (e.g., 812A, 818A, 824A), and causing display of the visual output in the second display state includes causing display of second content associated with the second subject (e.g., 812B, 818B, 824B). For example, displaying of the visual output in the first display state includes displaying, surfacing, and/or emphasizing visual content relating to or representing the first subject, and displaying the visual output in the second state includes displaying, surfacing, and/or emphasizing visual content relating to or representing the second subject, e.g., as illustrated in FIGS. 8A and 8B-8H)

In some embodiments, the first utterance includes a first word (in some embodiments, one or more words) corresponding to the first subject (e.g., “pink,” “Doctor Show,” “Today”) and the second utterance includes a second word (in some embodiments, one or more words) corresponding to the second subject (e.g., “blue,” “Reality Contest,” “Tonight”). In some embodiments, the first content corresponding to the first subject includes text of the first word (e.g., 812A, 818A, 824A), and the second content corresponding to the second subject includes text of the second word (e.g., 812B, 818B, 824B). In some embodiments, causing display of the visual output in the first display state includes visually emphasizing the text of the first word, and causing display of the visual output in the second display state includes visually emphasizing the text of the second word (e.g., turning the text “pink” the color pink while saying “pink” and turning the text “blue” the color blue while saying “blue,” moving the text blurb about John to the top of the screen while saying “John” and moving the text blurb about Ringo to the top of the screen while saying “Ringo”). For example, visually emphasizing text may include bolding, italicizing, underlining, marking, highlighting, changing the color of, and/or moving the text relative to its previous appearance and/or relative to other displayed elements.

In some embodiments, the speech output includes a third utterance corresponding to a third subject that is different from the first subject and the second subject (e.g., “George,” “Miniseries” (816C), and/or “Tomorrow night has a chance of rain” (824C)). In some embodiments, in accordance with the determination that the synchronization criteria are satisfied, at a third time while outputting the speech output that is different from the first time and the second time, the system implementing method 900 causes display of the visual output in a third display state that is different from the first display state and the second display state (e.g., 818C and/or 824C), wherein causing display of the visual output in the third display state includes causing display of third content corresponding to the third subject (e.g., as described with respect to FIGS. 8C-8E) (e.g., displaying a photo and text blurb about George while outputting the speech “George,” or displaying a forecast widget for tomorrow while outputting the speech “Tomorrow night has a chance of rain.”). In some embodiments, the third utterance is output (or scheduled for output) at or near the third time, e.g., the third utterance is output while the visual output is displayed in the third state.

In some embodiments, causing display of the visual output includes generating a set of instructions (e.g., 813) including a first instruction for displaying the visual output in the first display state and a second instruction for displaying the visual output in the second display state (e.g., described with respect to FIG. 8B). In some embodiments, the instructions include instructions for displaying the visual output in the respective state at the respective time while outputting the speech output (e.g., the instructions include display timing instructions). In some embodiments, the instructions include application instructions, e.g., for causing one or more applications to display the visual output in the first and second states and/or causing the applications to provide display content to be included in the visual output in the first and second states. In some embodiments, the instructions include actionable intent objects and/or intent parameters (e.g., as described with respect to 813A and 813B). In some embodiments, generating the set of instructions includes encoding (e.g., embedding as markup, such as tags, labels, and/or pointers) the set of instructions into a representation of the speech output (e.g., a textual representation of the speech output, e.g., for converting to speech using a text-to-speech service). In some embodiments, generating the set of instructions is performed in response to receiving the user request directed to the digital assistant system. In some embodiments, the digital assistant system generates the set of instructions at least in part, e.g., as part of responding to the user request, the DA system may determine actionable intents and/or parameters that can be provided to other applications and/or services.

In some embodiments, causing the display of the visual output includes providing the set of instructions to a set of one or more applications (e.g., providing the first instruction for displaying the visual output in the first state to a first application, and providing the second instruction for displaying the visual output in second first state to a second application, which may be the same application or a different application than the first application). In some embodiments, providing a respective instruction to a respective application causes (e.g., triggers) the application to display the visual output in the respective display state, e.g., either upon receipt of the instruction or at a scheduled time. For example, a digital assistant can generate an actionable intent object (e.g., for a display action) for each response element (e.g., including the response element as a parameter) to provide to an application to allow the application to generate a corresponding visual output for the response element (e.g., using the application's own resources and capabilities). For example, providing a display intent object with the episode of the doctor show as a parameter to a streaming application causes the streaming application to display visual output 818 with visual output 818A (corresponding to the episode of the doctor show) emphasized/focused, providing a display intent object with the episode of the reality show as a parameter to the streaming application causes the streaming application to display visual output 818 with visual output 818B emphasized, and providing a display intent object with the episode of the miniseries as a parameter to the streaming application causes the streaming application to display visual output 818 with visual output 818C emphasized. In some embodiments, the set of instructions may be provided to multiple applications. For example, in response to a user request such as “Hey Assistant, list my television queue, and what's the forecast?,” a digital assistant may provide one or more display instructions (e.g., for each determined element of the user's television queue) to one or more streaming applications (e.g., triggering the streaming applications to display, emphasize, and/or provide display content for visual outputs 818A, 818B, and/or 818C) and provide one or more display instructions (e.g., for each determined element of the forecast) to a weather application (e.g., triggering the weather application to display, emphasize, and/or provide display content for visual outputs 824A, 824B, 824C, and/or 824D).

In some embodiments, the system implementing method 900 obtains, from the set of one or more applications, metadata identifying a plurality of display states (e.g., visual outputs available, e.g., via the one or more applications) including the first display state and the second display state. For example, the metadata identifying a respective display state of the plurality of display states includes data identifying candidate emphasis subjects (e.g., response utterances, topics, entities, intents, and/or parameters) associated with (e.g., corresponding to) the respective display state. For example, metadata from a streaming application may identify display content relating to the streaming application's entities (e.g., available television episodes, movies, series, playlists, etc.), such that a digital assistant can generate display instructions for the episodes in the user's television queue using the application display content (e.g., either using the identified content to generate a visual output or instructing the streaming application to display the identified content using its own resources and capabilities). As another example, metadata from a weather application may identify display states associated with intents to provide forecasts for any particular time window, date, or range of time for the next two months, such that the digital assistant can generate instructions corresponding to the display states for today, tonight, tomorrow, and the weekend.

In some embodiments, generating the set of instructions includes, in accordance with a determination, based on the metadata, that the speech output includes an utterance associated with the first display state (e.g., an utterance associated with a candidate emphasis subject associated with the first display state), generating the first instruction for displaying the visual output in the first display state. In some embodiments, the utterance associated with the first display state includes the first utterance associated with the first subject, and the metadata indicates that the first display state is associated with the first subject and/or identifies the first content corresponding to the first subject. For example, as speech output 822A includes the utterance “Today” and the application metadata for the weather application indicates the availability of display content corresponding to today's weather, the digital assistant instructs the weather application to display visual output 824A with the corresponding display content. In some embodiments, generating the set of instructions includes, in accordance with a determination, based on the metadata, that the speech output includes an utterance associated with the second display state (e.g., an utterance associated with a candidate emphasis subject associated with the second display state), generating the second instruction for displaying the visual output in the second display state. In some embodiments, the utterance associated with the second display state includes the second utterance associated with the second subject, and the metadata indicates that the second display state is associated with the second subject and/or identifies the second content corresponding to the second subject. For example, as spoken output 822B includes the utterance “Tonight” and the application metadata for the weather application indicates the availability of display content corresponding to tonight's weather, the digital assistant instructs the weather application to display visual output 824B with the corresponding display content.

In some embodiments, providing the set of instructions to the set of one or more applications includes, while (e.g., in the course of) outputting, via the digital assistant system, a fourth utterance of the speech output, providing the first instruction for displaying the visual output in the first display state to a first application of the set of one or more applications (in some embodiments, the fourth utterance includes the first utterance associated with the first subject, and in some embodiments, the fourth utterance includes the utterance associated with the first display state, e.g., as indicated by the application metadata) and, while (e.g., in the course of) outputting, via the digital assistant system, a fifth utterance of the speech output, providing the first instruction for displaying the visual output in the first display state to a second application of the set of one or more applications (in some embodiments, the fifth utterance includes the second utterance associated with the second subject, and in some embodiments, the fifth utterance includes the utterance associated with the second display state, e.g., as indicated by the application metadata). In some embodiments, outputting the fourth utterance is performed at the first time and outputting the fifth utterance is performed at the second time (e.g., the visual output is displayed in the first display state at the actual time of delivery for the fourth utterance and the visual output is displayed in the second display state at the actual time of delivery for the fifth utterance). For example, at least some display instructions are provided “live” as the speech output is ongoing to synchronize the state of the visual output with the speech content being delivered. For example, while outputting spoken output 816A (“You have new episodes of Doctor Show . . . ”), the digital assistant instructs a streaming application to display visual output 818 with visual output 818A emphasized, while outputting spoken output 816B (“ . . . . Reality Contest . . . ”), the digital assistant instructs the streaming application to update visual output 818 to emphasize visual output 818B, and while outputting spoken output 816C (“ . . . and Mini Series to watch.”), the digital assistant instructs the streaming application to update visual output 818 to emphasize visual output 818C (e.g., as illustrated in FIG. 8C). As another example, as discussed with respect to FIG. 8G, while outputting speech output 822A (“Today will be sunny and warm . . . ”), the digital assistant may instruct the weather application to display visual outputs 824A and 824B, and while outputting spoken output 822C (“Tomorrow night has a chance of rain”), the digital assistant may instruct the weather application to display visual outputs 824C and 824D.

In some embodiments, in response to receiving the user request directed to the digital assistant system, the system implementing method 900 generates (in some embodiments, via the digital assistant system) a representation of the speech output (in some embodiments, a textual, phonemic, and/or tokenized representation that can be converted to synthesized speech for output, e.g., using a text-to-speech service). In some embodiments, outputting the speech output includes converting the representation to synthesized speech. In some embodiments, the system implementing method 900 encodes (e.g., as markup, such as tags, labels, and/or pointers) a portion of the representation of the speech output that corresponds to the fourth utterance (in some embodiments, text representing the fourth utterance) with at least a portion of the first instruction for displaying the visual output in the first display state, and encodes a portion of the representation of the speech output that corresponds to the fifth utterance (in some embodiments, text representing the fifth utterance) with at least a portion of the second instruction for displaying the visual output in the second display state. In some embodiments, converting a respective portion of the representation into speech causes any encoded instructions to be transmitted/executed, e.g., the instructions are encoded as actionable markup of the speech output. For example, outputting the first/second utterance triggers the visual state change. For example, a digital assistant may generate a representation of spoken output 816 (“You have new episodes of Doctor Show, Reality Contest, and Mini Series to watch”), where the display instructions for the display state emphasizing visual output 818A are embedded in the representation of spoken output 816A (“You have new episodes of Doctor Show . . . ”), the display instructions for the display state emphasizing visual output 818B are embedded in the representation of speech output 816B (“ . . . . Reality Contest . . . ”), and the display instructions for the display state emphasizing visual output 818C are embedded in the representation of speech output 816C (“ . . . and Mini Series to watch . . . ”). When the representation of speech output 816A is converted to audible speech (e.g., spoken output 816A is output), the embedded instructions are sent to the streaming application, causing the streaming application to display visual output 818 with visual output 818A highlighted (e.g., and so forth for spoken output 816B and spoken output 816C).

In some embodiments, the first instruction for displaying the visual output in the first display state includes an instruction to display the visual output in the first display state at the first time, and the second instruction for displaying the visual output in the second display state includes an instruction to display the visual output in the second display state at the second time. For example, the set of instructions includes timing instructions for the execution of the display instructions. In some embodiments, the first time and second time are scheduled or estimated times of delivery for portions of the speech output corresponding to the different display states. For example, the speech output and visual output are scheduled (e.g., by the digital assistant) to synchronize output. In some embodiments, the first time is an estimated time of delivery of a sixth utterance of the speech output (e.g., an utterance associated with the first display state, such as the first or fourth utterance) and the second time is an estimated time of delivery of a seventh utterance (e.g., an utterance associated with the second display state, such as the second or fifth utterance). In some embodiments, the digital assistant system estimates the first and second times. For example, the digital assistant may generate instructions to display visual output 824 including the expected synthesized speech timing for spoken output 822 (“Today will be sunny and warm with cloudy conditions overnight. Tomorrow night has a chance of rain, and the weekend will be cloudy but warm”), such that the state of visual output 824 is displayed/updated at or during the expected delivery times for spoken output 822A, spoken output 822B, spoken output 822C, and/or spoken output 822D (e.g., as described with respect to FIGS. 8D-8H).

In some embodiments, causing display of the visual output includes causing display of a user interface (e.g., 812, 818, and/or 824). In some embodiments, the user interface includes an application user interface (e.g., for an application different from the digital assistant system, in some embodiments, an application of the one or more applications that execute the display instructions). In some embodiments, causing display of the application user interface includes launching (e.g., opening and/or surfacing) the application. For example, visual output 818 may include a television queue user interface of the streaming application.

In some embodiments, causing display of the visual output in the first display state includes causing display of the user interface including third content (e.g., a first set of one or more user interface elements, text, and/or graphics; in some embodiments, the third content includes the first content associated with the first subject) and not including fourth content (e.g., a second set of one or more user interface elements, text, and/or graphics; in some embodiments, the fourth content includes the second content associated with the second subject). For example, in the first display state, the third content is displayed and the fourth content is not displayed. In some embodiments, in the first display state, only the third content is displayed (e.g., as described with respect to FIGS. 8A and 8H). In some embodiments, causing display of the visual output in the second display state includes causing display of the user interface including the fourth content and not including the third content. For example, in the second display state, the fourth content is displayed and the third content is not displayed. In some embodiments, in the second display state, only the fourth content is displayed (e.g., as described with respect to FIG. 8A. For example, changing the display state of the visual output includes entirely refreshing the contents of the user interface. For example, changing the display state of the visual output includes a “slideshow” type display, where content related to emphasis subjects included in the speech input is displayed sequentially, e.g., one emphasis subject at a time, in some embodiments, with or without overlap.

In some embodiments, causing display of the visual output in the first display state includes causing a first element of the user interface (in some embodiments, the first element includes the first content and/or the third content) to be visually emphasized (e.g., compared to one or more other displayed elements of the user interface; e.g., bolding, italicizing, underlining, highlighting, coloring, enlarging, marking, animating, or otherwise increasing the visual prominence of the first element), and causing display of the visual output in the second display state includes causing a second element of the user interface (in some embodiments, the second element includes the second content and/or the fourth content), different from the first element, to be visually emphasized (e.g., as described with respect to FIGS. 8C-8G). In some embodiments, visually emphasizing one element of the user interface includes de-emphasizing other elements of the user interface, e.g., de-emphasizing the second element when in the first display state and/or de-emphasizing the first element when in the second display state. For example, changing the display state of the visual output includes a “karaoke”/“singalong” type display, where content related to emphasis subjects included in the speech input is emphasized sequentially, e.g., one emphasis subject at a time, in some embodiments, with or without overlap.

In some embodiments, causing display of the visual output in the first display state includes causing a third element to be displayed at a first position in the user interface (in some embodiments, moving (and/or animating movement of) the third element into the first position from a previous position), and causing display of the visual output in the second display state includes causing a fourth element to be displayed at a second position in the user interface (in some embodiments, moving the fourth element into the second position from a previous position), for example, as illustrated in FIG. 8D. In some embodiments, the third element and fourth element are different elements, and the first position and the second position are the same, e.g., the display state determines which element is displayed at a particular position, such as at the top of a list, the middle of a carousel, or an emphasized/active area of the user interface. In some embodiments, the third element and the fourth element are the same element, and the first position and the second position are different, e.g., a given element is moved around as the display state changes. In some embodiments, the third element and fourth element are different elements, and the first position and second position are different, e.g., as the display state changes, different elements appear, disappear, and/or move around the user interface. For example, the visual output state change is presented as a “scroll” or “list” type display, moving emphasis subjects into focus in turn.

In some embodiments, the synchronization criteria include a first criterion that is satisfied when the display (e.g., the display being used to provide the visual output) has a first form factor (e.g., a particular size or range of sizes, a particular type (e.g., a watch, mobile phone, tablet, laptop, monitor, home hub, or television-type display), or a particular aspect ratio). In some embodiments, if the display has a form factor other than the first form factor, causing display of the visual output may include displaying the visual output in different states than the first/second display state and/or changing the display state while outputting the speech input at times other than the first/second time (e.g., the way in which the visual output is synchronized to the speech output differs on displays of different form factors). For example, a small form-factor device (e.g., 802A) may satisfy synchronization criteria for displaying a visual output with display states that include only one response element at a time (e.g., a “slideshow” synchronization, as described with respect to FIGS. 8A, 8E, and 8H). As another example, a larger form-factor device (e.g., 802B and/or 802C) may satisfy synchronization criteria for displaying a visual output with display states that include multiple response element at a time (e.g., a “scrolling” or “follow-along” synchronization, as described with respect to FIGS. 8C-8D and 8F-8G). In some embodiments, if the display has a form factor other than the first form factor, causing display of the visual output may include displaying the visual output in a single display state while outputting the speech output (e.g., for some display form factors, the visual output is not synchronized to the speech output). For example, on a smaller form factor display, causing display of the visual output may include changing the display state more frequently and/or displaying less information at one time, and on a larger form factor display, causing display of the visual output may include changing the display state less frequently (or not at all) and/or displaying more information at one time. As another example, on a personal- or wearable-type display, such as a mobile phone, watch, or laptop, causing display of the visual output may include changing the display state less frequently (or not at all), and on a communal-type display, such as a home hub, television, or tablet, causing display of the visual output may include changing the display state more frequently.

In some embodiments, the synchronization criteria include a first proximity criterion that is satisfied when a detected proximity of a user (e.g., proximity of the user to the electronic device and/or the display; in some embodiments, detected using one or more sensors, such as proximity sensors, depth sensors, cameras, and/or motion sensors; in some embodiments, detected using a proxy device, such as a location or state of the user's watch, headset, or mobile phone) is within a threshold proximity range (e.g., less than five feet away, three to seven feet away, more than twenty feet away, within the same room, in the front seats of a car, or currently wearing the device). In some embodiments, if the user is detected within a particular proximity range other than the threshold proximity range, causing display of the visual output may include displaying the visual output in different states than the first/second display state and/or changing the display state while outputting the speech input at times other than the first/second time (e.g., the way in which the visual output is synchronized to the speech output differs based on user proximity, e.g., as discussed further below). For example, detecting a user in close proximity may satisfy synchronization criteria for displaying a visual output with display states that include multiple response element at a time (e.g., a “scrolling” or “follow-along” synchronization, as described with respect to FIGS. 8C-8D and 8F-8G). As another example, detecting a user with low proximity may satisfy synchronization criteria for displaying a visual output with display states that include only one response element at a time (e.g., a “slideshow” synchronization, as described with respect to FIGS. 8A, 8E, and 8H). For example, when a user is close to the device/display, causing display of the visual output may include changing the display state less frequently (or not at all), and when a user is farther away from the device/display, causing display of the visual output may include changing the display state more frequently.

In some embodiments, causing the display of the visual output includes, in accordance with a determination that the proximity criterion is not satisfied (e.g., when the user is outside of a specified range away from the device/display), causing display of the visual output in a respective display state at a respective time while outputting the speech output. In some embodiments, in accordance with a determination that the proximity criterion is not satisfied and in accordance with a determination that a second set of synchronization criteria are satisfied (in some embodiments, including a second proximity criterion satisfied when the proximity of the user is within a different proximity range), the digital assistant also causes display of the visual output in another display state at a different time than the respective time while outputting the speech output (e.g., visual outputs are synchronized to the speech output in a different way when the proximity criterion/synchronization criteria are not satisfied). In some embodiments, in accordance with a determination that the proximity criterion is not satisfied (and, in some embodiments, in accordance with a determination that a second set of synchronization criteria are not satisfied), the digital assistant foregoes synchronizing the visual output with the speech output, e.g., the digital assistant only displays the visual output in the respective display state during the speech output, without synchronizing to the speech output. For example, for synchronization criteria that include a requirement that a user is in low proximity to the device (e.g., over ten feet away), if the user is detected twelve feet away, the system will update the state of display output to display one response element at a time (e.g., as described with respect to FIG. 8H), but if the user is detected six inches away, the system will instead update the state of the display output to display all response elements at once (e.g., with synchronized emphasis, as described with respect to FIG. 8F, or without updating at all).

In some embodiments, the synchronization criteria include a content criterion that is satisfied when the visual output includes content of a respective type (e.g., a particular amount, size, complexity, or legibility of content; e.g., text, photos, illustrations, or symbols). For example, the synchronization criteria may be satisfied if the visual output includes a large amount of text (e.g., text messages or search results) or photographs, which would be more legible to a user if displayed in smaller segments, and the synchronization criteria may not be satisfied if the visual output includes less text (e.g., a grocery list) or only symbols (e.g., simple pictograms of weather conditions), which may be easier to read or view even at a smaller size.

In some embodiments, causing the display of the visual output includes, in accordance with a determination that the synchronization criteria are not satisfied (in some embodiments, and in accordance with a determination that a second set of synchronization criteria are not satisfied), causing display of the visual output in a fourth display state at a fourth time while outputting the speech output; and foregoing causing display of the visual output in a display state other than the fourth display state while outputting the speech output. For example, if the synchronization criteria are not satisfied, the visual output is displayed without synchronizing to the speech output. For example, with reference to the example illustrated in FIG. 8F (e.g., a user sitting close to device 802C for delivery of spoken output 822 and visual output 824), the synchronization criteria may not be met because, e.g., device 802C is a large form-factor device (e.g., failing to satisfy a criterion requiring a smaller device), user 826 is in close proximity (e.g., failing to satisfy a criterion requiring a further distance), and/or because visual output 824 only contains simple text and icons (e.g., failing to satisfy a criterion requiring more detailed content). Accordingly, rather than synchronize spoken output 822 and visual output 824 as described above, system 800 may statically display visual outputs 824A-824D while delivering spoken output 822, e.g., as described with respect to FIG. 8F but without including or updating border element 828.

In some embodiments, in response to receiving the user request directed to the digital assistant system, the system implementing method 900 generates, via the digital assistant system (e.g., via a TTS or other voice model), the speech output, wherein the speech output includes synthesized speech.

Note that details of the processes described above with respect to method 900 (e.g., FIG. 9) are also applicable in an analogous manner to the other systems methods described herein. For example, synchronizing multi-part responses to user requests with display content as described with respect to method 900 may include generating the multi-part response as described with respect to method 1000. For brevity, these details are not repeated herein.

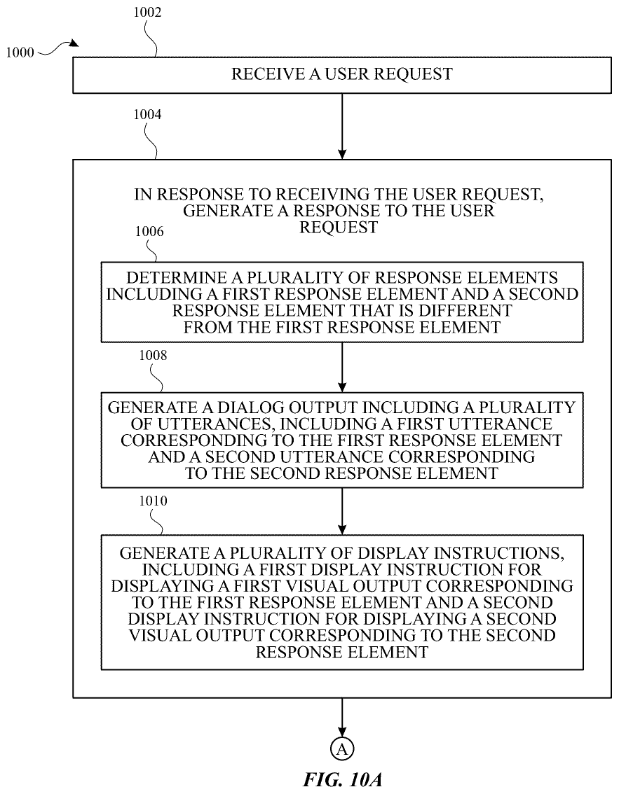

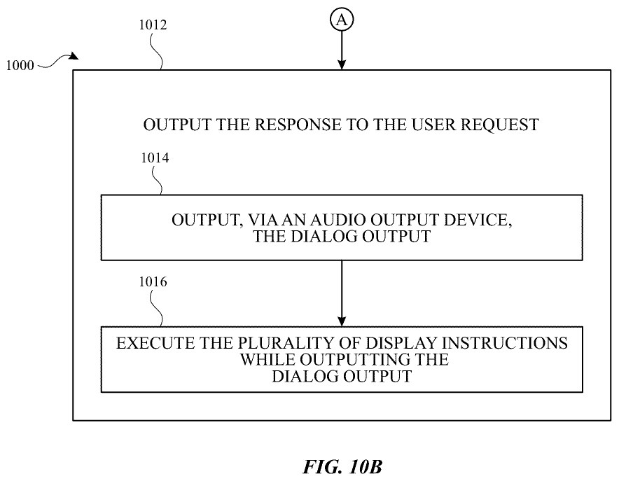

FIGS. 10A-10B illustrate a flow diagram of method 1000 for generating multi-part responses with spoken and displayed elements in accordance with some embodiments. Method 1000 may be performed using one or more electronic devices (e.g., device 104, device 200, device 600, device 802A, device 802B, device 802C) with one or more processors, memory, and, optionally, display generation components (e.g., 804). In some embodiments, method 1000 is performed using a client-server system, with the operations of method 1000 divided up in any manner between the client device(s) (e.g., 104, 200, 600, 802A, 802B, 802C) and the server. Some operations in method 900 are, optionally, combined, the orders of some operations are, optionally, changed, and some operations are, optionally, omitted.

The system implementing method 1000 (e.g., 802A, 802B, and/or 802C) receives (1002) (e.g., via one or more input devices, such as a microphone, touch-sensitive surface, button, keyboard, stylus, and/or sensor) a user request (e.g., 806, 814, and/or 820). In some embodiments, the user request includes a natural-language input, such as a speech or text input, e.g., “What are my favorite colors?,” “Hey Assistant, what shows do I have?,” “Assistant, give me a weather report,” or “Who are the members of Rock Band?” In some embodiments, the user request includes another input corresponding to a request, such as a selection of a suggestion affordance (e.g., “Tap to learn more about Rock Band”) or a request to set up an automated feature (e.g., setting up a digital assistant to provide a daily weather report). In some embodiments, the user request includes a trigger, such as a digital assistant trigger (e.g., a phrase such as “Hey Assistant” or “Assistant,” a button press, a user interface input, or a gaze input at a digital assistant user interface object) or an asynchronous trigger (e.g., a request to the digital assistant to provide a response at a certain time or under other conditions).

In response to receiving the user request, the system implementing method 1000 generates (1004) a response to the user request (e.g., 810 and 812, 816 and 818, and/or 822 and 824). Generating (1004) the response to the user request includes determining (1006) (e.g., based on the user request) a plurality of response elements (e.g., 808A, 808B) (e.g., emphasis subjects) including a first response element and a second response element that is different from the first response element. For example, the response elements (e.g., emphasis subjects) represent a set of key points of a response to the user input, such as “pink” and “blue” for a response to “What are my favorite colors?”; “John,” “Paul,” “George,” and “Ringo” for a response to “Who are the members of Rock Band?”; or “today,” “tomorrow,” and “this weekend” for a response to “Give me a weather report.”

Generating (1004) the response to the user request further includes generating (1008) a dialog output (e.g., 810, 816, and/or 822) (in some embodiments, a natural language dialog output, such as generative or template-based dialog; in some embodiments, the dialog output includes a textual representation of speech to be output) including a plurality of utterances (e.g., words, phrases, clauses, and/or sentences), wherein the plurality of utterances includes a first utterance corresponding to the first response element (e.g., 810A, 816A, and/or 822A) and a second utterance corresponding to the second response element (e.g., 810B, 816B, and/or 822B). For example, the dialog output includes a response to the user request, such as “Your favorite colors are pink and blue,” “You have new episodes of Doctor Show, Reality Contest, and Miniseries available to watch,” “Rock Band has four members: John, Paul, George, and Ringo,” “Today, it's going to be sunny and warm. There's a chance of rain tomorrow night, but the weekend should have clear skies.” Generating (1004) the response to the user request further includes generating (1010) a plurality of display instructions (e.g., 813), wherein the plurality of display instructions includes a first display instruction (e.g., 813A) for displaying a first visual output corresponding to the first response element (e.g., a first display state) and a second display instruction (e.g., 813B) for displaying a second visual output corresponding to the second response element (e.g., a second display state) (e.g., as discussed with respect to FIG. 8B).

The system implementing method 1000 outputs (1010) the response to the user request. Outputting (1010) the response includes outputting (1012), via an audio output device, the dialog output. For example, the dialog output is synthesized as speech, such as speech of a digital assistant system. Outputting (1010) the response further includes while outputting the dialog output, executing the plurality of display instructions. For example, executing the plurality of display instructions causes display of the first visual output and causes display of the second visual output. For example, executing the display instructions includes displaying a pink screen with the text “pink” and a blue screen with the text “blue”; displaying and/or emphasizing list items with thumbnails and episode information for Doctor Show, Reality Contest, and Miniseries; displaying and/or emphasizing list items with photos of John, Paul, George, and Ringo of Rock Band; and/or displaying and/or emphasizing forecast user interfaces for today, tonight, tomorrow, and the weekend. In some embodiments, instructions of the plurality of display instructions may be executed at the same time or at different times (e.g., sequentially). In some embodiments, the plurality of display instructions are executed by providing (e.g., inputting and/or transmitting) the instructions to an appropriate application, daemon, or other service.

In some embodiments, executing the plurality of display instructions includes causing display of the first visual output corresponding to the first response element (e.g., the first display state) while outputting the first utterance corresponding to the first response element; and causing display of the second visual output corresponding to the second response element (e.g., the second display state) while outputting the second utterance corresponding to the second response element (e.g., synchronizing corresponding audio and visual outputs). For example, executing the plurality of display instructions includes displaying visual output 818 with visual output 818A (e.g., the display element for the doctor show) emphasized while outputting spoken output 816A (“You have new episodes of Doctor Show . . . ”) and displaying visual output 818 with visual output 818B (e.g., the display element for the reality show) emphasized while outputting spoken output 816B (“ . . . . Reality Contest . . . ”).

In some embodiments, generating the response to the user request includes annotating (e.g., marking up, embedding, appending, etc.; in some embodiments, using an output/response coordinator module) the dialog output with the plurality of display instructions, including annotating the first utterance corresponding to the first response element (e.g., 810A) with the first display instruction (e.g., 813A) and annotating the second utterance corresponding to the second response element (e.g., 810B) with the second display instruction (e.g., 813B). In some embodiments, executing the plurality of display instructions includes, in response to outputting the first utterance corresponding to the first response element, executing the first display instruction; and in response to outputting the second utterance corresponding to the second response element, executing the second display instruction (e.g., outputting the annotated dialog output triggers execution of display instructions). For example, converting a representation of the first utterance into synthesized speech for audible output produces a first event that causes execution of the first display instruction, and converting a representation of the second utterance into synthesized speech for audible output produces a second event that causes execution of the second display instruction.

In some embodiments, generating the response to the user request includes generating (in some embodiments, using an output/response coordinator module), based on the dialog output, display timing instructions (e.g., as described with respect to 813A and 813B in FIG. 8B). For example, the display timing instructions represent predicted or scheduled times of delivery for the plurality of utterances included in the dialog output. In some embodiments, executing the plurality of display instructions includes executing the first display instruction at a first time specified by the display timing instructions (e.g., a predicted or scheduled time of delivery for the first utterance) and executing the second display instruction at a second time specified by the display timing instructions that is different from the first time (e.g., a predicted or scheduled time of delivery for the second utterance).

In some embodiments, outputting the response includes, in accordance with a determination that a set of synchronization criteria is satisfied, synchronizing outputting the dialog output and executing the plurality of display instructions (e.g., coordinating when the various utterances of the plurality of utterances are output with when the various visual outputs instructed in the plurality of display instructions are displayed) (e.g., as described with respect to FIG. 9). For example, when the first set of criteria are satisfied, the system coordinates delivery of utterances and visual outputs corresponding to the same response elements to be output together (e.g., at the same or similar times), as described with respect to FIGS. 8A and 8C-8H). In some embodiments, outputting the response includes, in accordance with a determination that the set of synchronization criteria is not satisfied, foregoing synchronizing outputting the dialog output and executing the plurality of display instructions (e.g., as described with respect to FIG. 8F). For example, when the first set of criteria are not satisfied, the system displays a visual output corresponding to all of the response elements included in the response to the user request at one time.

In some embodiments, the set of synchronization criteria includes a first proximity criterion that is satisfied when a detected proximity of a user (e.g., proximity of the user to the electronic device and/or the display; in some embodiments, detected using one or more sensors, such as proximity sensors, depth sensors, cameras, and/or motion sensors; in some embodiments, detected using a proxy device, such as a location or state of the user's watch, headset, or mobile phone) is within a first threshold proximity range (e.g., less than five feet away, three to seven feet away, more than twenty feet away, within the same room, in the front seats of a car, or currently wearing the device). For example, when a user is close to the device/display, the dialog and visual outputs may not be synchronized, and when a user is farther away from the device/display, the dialog and visual outputs may be synchronized, e.g., as described with respect to FIGS. 8F-8H.

In some embodiments, the set of synchronization criteria includes a content criterion that is satisfied when the plurality of response elements includes content of a respective type (e.g., as discussed with respect to FIG. 8H) (e.g., a particular amount, size, complexity, or legibility of content; e.g., text, photos, illustrations, or symbols). For example, the synchronization criteria may be satisfied if the visual output includes a large amount of text (e.g., text messages or search results) or photographs, which would be more legible to a user if displayed in smaller segments, and the synchronization criteria may not be satisfied if the visual output includes less text (e.g., a grocery list) or only symbols (e.g., simple pictograms of weather conditions), which may be easier to read or view even at a smaller size.

In some embodiments, synchronizing outputting the dialog output and executing the plurality of display instructions includes executing the first display instruction at a first time while outputting the dialog output and executing the second display instruction at a second time, different from the first time, while outputting the dialog output (e.g., visual outputs are displayed sequentially, with or without overlap). For example, when synchronizing visual output 824 and spoken output 822 as described with respect to FIG. 8E, system 800 may execute display instructions for visual output 824A, visual output 824B, visual output 824C, and visual output 824D one at a time, in sequence. In some embodiments, foregoing synchronizing outputting the dialog output and executing the plurality of display instructions includes executing the first display instruction and executing the second display instruction at a third time while outputting the dialog output (e.g., visual outputs are displayed simultaneously). For example, when synchronizing visual output 824 and spoken output 822 as described with respect to FIG. 8F, system 800 may execute display instructions for visual output 824A, visual output 824B, visual output 824C, and visual output 824D to all be displayed at the same time.

In some embodiments, executing the plurality of display instructions includes, in accordance with a determination that a first set of context criteria is satisfied executing the first display instruction in a first manner and executing the second display instruction in a second manner; (e.g., displaying the visual outputs with particular timing (e.g., start time, duration, and/or end time for displaying the visual outputs, e.g., relative to the output of the dialog output and/or relative to the execution of other display instructions) and/or with a particular appearance (e.g., size, visual emphasis/prominence, format, level of detail, transition animation, etc.; e.g., relative to other displayed content, including other visual outputs of the response to the user request) based on current context. In some embodiments, executing the plurality of display instructions includes, in accordance with a determination that the first set of context criteria is not satisfied executing the first display instruction in a manner different from the first manner (e.g., displaying the first visual output with different timing and/or a different appearance than when the first context criteria are satisfied) and executing the second display instruction in a manner different from the second manner (e.g., as discussed with respect to FIGS. 8D-8H) (e.g., displaying the second visual output with different timing and/or a different appearance than when the second context criteria are satisfied). For example, based on current context, such as the proximity of a user, device/display form factor, user preferences/settings, content for delivery, location, time of day, or the like, the display instructions are executed differently, such that the visual outputs are tailored to the current context. In some embodiments, in accordance with a determination that a second set of context criteria, different from the first set, is satisfied, the first display instruction is executed in a third manner different from the first manner, and the second display instruction is executed in a fourth manner different from the second manner; in accordance with a determination that neither the first nor second set of context criteria are satisfied, the first display instruction is executed in a fifth manner different from the first and third manner, and the second display instruction is executed in a sixth manner different from the second and fourth manner. For example, FIGS. 8D-8H illustrate providing visual output 824A (corresponding to spoken output 822A/today's weather forecast) in four different manners based on context such as the device being used (e.g., 802A, 802B, and/or 802C) and the proximity of user 826.

In some embodiments, the first set of context criteria includes a display criterion that is satisfied when a display generation component used to display the first visual output and the second visual output when executing the plurality of display instructions includes a first type of display (e.g., 804A, 804B, and/or 804C) (e.g., a display with a particular size, aspect ratio, feature (e.g., always-on, touch-sensitive, wearable, etc.), or other characteristic). For example, for a small device/display such as a smart watch, the first and second display instruction may be executed sequentially, without overlap, and in a manner that reduces the amount of detail in and/or increases the legibility of the first visual output and/or second visual output, whereas for a large device/display such as a laptop, the first and second display instruction may be executed at the same time and in a manner such that the first visual output and second visual output are displayed together, with a greater amount of detail than on the watch (e.g., as described with respect to FIGS. 8D-8H, illustrating providing visual output 824 with devices 802A, 802B, and 802C).

In some embodiments, the first set of context criteria includes a second proximity criterion that is satisfied when a detected proximity of a user is within a second threshold proximity range. For example, as illustrated in FIGS. 8F-8H, system 800 displays and synchronizes visual output 824 in different manners depending on the proximity of user 826 to device 802C, e.g., displaying visual output 824 at a smaller size and updating less often while user 826 is a moderate distance from device 802C at FIG. 8G and displaying visual output 824 at a larger size and updating more often while user 826 is a farther distance from device 802C at FIG. 8H.

In some embodiments, the system implementing method 1000 obtains, from one or more applications, metadata indicating a plurality of candidate response elements (e.g., candidate response information) including the first response element and the second response element, wherein determining the plurality of response elements is based at least in part on the metadata indicating the plurality of candidate response elements (in some embodiments, and the user request) (e.g., as discussed with respect to method 900, above). In some embodiments, the application metadata may identify information that can be used in a response, as well as whether visual outputs corresponding to the information are available. For example, metadata for a music application may provide the names of the members of Rock Band and indicate that visual outputs for each of the members are available, for instance, using pictures, graphics, or text provided by the music application and/or output directly by the music application (e.g., using the music application's UI).

In some embodiments, outputting the dialog output includes providing the dialog output (e.g., the generated dialog output) to a speech synthesis system, wherein the speech synthesis system outputs, via the audio output device, the dialog output as synthesized speech. In some embodiments, for a dialog output with annotated/embedded display instructions, the speech synthesis system may generate events/trigger the execution of display instructions upon outputting the first utterance and the second utterance as synthesized speech. In some embodiments, the speech synthesis system is included in a digital assistant system. In some embodiments, the user request is directed to the digital assistant system. In some embodiments, the digital assistant system generates the response to the user request at least in part (e.g., parsing the user request and determining how to respond; in some embodiments, based on application metadata received from other applications). In some embodiments, the digital assistant system outputs the response at least in part (e.g., outputting the dialog output as synthesized speech, displaying visual outputs, coordinating the display of visual outputs, and/or synchronizing the speech and visual outputs).

In some embodiments, executing the plurality of display instructions includes providing the plurality of display instructions to one or more applications (e.g., applications installed on the device/system; in some embodiments, applications other than a digital assistant system). In some embodiments, providing a display instruction to an application triggers the application to display the instructed visual output, e.g., synchronously (e.g., directly in response to receiving the instruction) or asynchronously (e.g., sending additional timing instructions for when the application should display the instructed visual output). For example, display instructions for outputs including visual outputs 818A-818C may be provided to a streaming application, and display instructions for outputs including visual outputs 824A-824D may be provided to a weather application. In some embodiments, a respective display instruction of the plurality of display instructions includes a respective intent object (e.g., 813A and/or 813B) (e.g., an actionable intent for an application and/or one or more parameters for carrying out the intent). In some embodiments, providing a respective display instruction for displaying a respective visual output of the plurality of display instructions to a respective application of the one or more applications causes the respective application to display the respective visual output (in some embodiments, synchronously (e.g., directly in response to receiving the instruction) or asynchronously (e.g., sending additional timing instructions for when the application should display the instructed visual output)).

Note that details of the processes described above with respect to method 1000 (e.g., FIGS. 10A-10B) are also applicable in an analogous manner to the other systems methods described above. For example, the response generation described with respect to method 1000 can be used when synchronizing spoken outputs and display states as described with respect to method 900. For brevity, these details are not repeated herein.

FIG. 11 is a block diagram illustrating system 1100 for generating responses with application integration, according to various examples. System 1100 is implemented, for example, using one or more electronic devices (e.g., a mobile device, a personal computer, a wearable electronic device, and/or a peripheral device; e.g., 104, 200, 400, 600, 802A, 802B, 802C, and/or 1200) implementing a digital assistant (e.g., digital assistant system 700). In some examples, system 1100 is implemented using a client-server system (e.g., system 100), and the functions of system 1100 are divided up in any manner between the server (e.g., DA server 106) and a client device (e.g., 104, 200, 400, 600, 802A, 802B, 802C, and/or 1200). In other examples, the functions of system 1100 are divided up between the server and multiple client devices. Thus, while some functions of system 1100 are described herein as being performed by particular devices of a client-server system, it will be appreciated that system 1000 is not so limited. In other examples, system 1100 is implemented using only a client device (e.g., 104, 200, 400, 600, 802A, 802B, 802C, and/or 1200) or only multiple client devices. Some functions of system 1100 are, optionally, combined, the order of some functions is, optionally, changed, and some functions are, optionally, omitted. In some examples, additional functions may be performed in combination with the described functions of system 900.

For example, system 1100 is implemented as part of a digital assistant system (e.g., digital assistant system 700, e.g., in conjunction with foundation system 770) for use in interpreting and operationalizing user intents from an input. For example, system 1100 is used when performing processes such as described with respect to FIGS. 8A-10B and 12A-13.

As illustrated in FIG. 11, system 1100 includes response generation module 1104, dialog output module 1110, and application module 1112. For example, system 1100 is implemented as part of a digital assistant system (e.g., digital assistant system 700). For example, system 1100 is used when performing processes such as described herein with respect to FIGS. 8A-10B and 12A-13.

Response generation module 1104 is configured to generate one or more responses to user request 1102. For example, user request 1102 includes one or more digital assistant inputs, natural-language inputs, and/or other prompts (e.g., as described above with respect to FIGS. 8A-10B) received by system 1100 (e.g., as speech, text, and/or other types of input). For example, response module 1104 uses semantic analysis, natural-language processing techniques, and/or other AI models (e.g., foundation system 770 and/or another LLM and/or generative AI system) to process user request 1102, to determine how to respond to user request 1102 (e.g., determining one or more tasks to be performed and/or one or more outputs to be output), and to provide the determined response (e.g., performing one or more tasks, outputting one or more outputs, and/or causing performance and/or output thereof by another application or service).

As illustrated in FIG. 11, as part of a response to user request 1102, response generation module 1104 generates dialog content 1106, which is provided to dialog output module 1108 and audibly output (e.g., using speakers, headphones, and/or other audio output devices in communication with system 1100) as dialog output 1110. For example, dialog content 1106 includes a natural-language response (e.g., text) generated based on user request 1102, and dialog output 1110 includes a synthetic speech output of the natural-language response (e.g., generated using a text-to-speech service of the digital assistant of dialog output module 1108).

Dialog content 1106 additionally includes markup information identifying one or more response elements (e.g., as described with respect to FIGS. 8A-10B) of the response to user request 1102. For example, the response elements represent candidate emphasis subjects (e.g., elements corresponding to key points of a natural-language response to the user input, such as “pink” and “blue” for a response to “What are my favorite colors?”) and/or other key items of information to be included in dialog output 1110.

The markup information identifying the one or more response elements is annotated and/or embedded into dialog content 1106 such that, while outputting dialog output 1110, dialog output module 1108 generates events 1106A corresponding to dialog content 1106. For example, when (e.g., shortly before, during, or after) dialog output module 1108 audibly outputs a portion of the natural-language response (e.g., a word or phrase) embedded with markup information corresponding to a particular response element is audibly output, dialog output module 1108 also generates an event corresponding to the particular response element, such that the timing of the event generation is synchronized with the output of the portion of the natural-language response. In some embodiments, dialog output module 1108 synchronizes the event generation with the output of dialog output 1110 as described with respect to FIGS. 8A-10B (e.g., generating events based on the actual and/or predicted (e.g., scheduled) delivery timing of a speech output).

As illustrated in FIG. 11, application module 1114 includes an event handler that detects events 1106A. In response to detecting events 1106A, application module 1114 determines whether to provide information 1106B, a portion of the markup information that triggered the event (e.g., information identifying the response element corresponding to the current portion of dialog output 1110), to one or more applications 1116 (e.g., via an API). In some embodiments, application module 1114 determines whether the response elements identified by events 1106A are associated with at least one user interface of the one or more applications 1116. For example, an application user interface is associated with a particular response element if the user interface includes a user interface element, text, image, graphic, and/or other display content that relates to the response element, such as a user interface element for controlling a device mentioned in the response, text from which portions of the response are excerpted, images illustrating portions of the response, or the like.

If a response element identified by events 1106A is associated with a particular user interface of a particular application of the one or more applications 1116, application module 1114 provides the application with the corresponding item of information 1106B (e.g., responsive to the detection of the event). In some embodiments, application module 1114 only provides information 1106B to the application if the associated user interface is currently displayed, if the application is currently displayed, and/or if the associated user interface and/or application are going to be displayed as part of the response to user request 1102 (e.g., as part of performing one or more tasks as described with respect to instructions 1118). In some embodiments, application module 1114 provides information 1106B to multiple different applications if the multiple different applications each have at least one associated user interface. Accordingly, application module 1114 provides information 1106B to applications 1116 if information 1106B is currently and/or potentially relevant to the user interfaces available via the one or more applications 1116.

By providing information 1106B to applications 1116, application module 1114 informs the one or more applications 1116 of when the current state of dialog output 1110 is relevant to the applications, which allows the one or more applications 1116 to synchronize their user interfaces and the content displayed therein with dialog output 1110. In some embodiments, the one or more applications 1116 include internal (e.g., developer-defined) logic for determining, whether and how to display, emphasize, and/or otherwise change the appearance of application content in response to receiving information 1106B. For example, in response to receiving an item of information 1106B, the application determines whether or not to display (e.g., navigate to) a user interface associated with the item of information 1106B, whether or not to emphasize content associated with the item of information 1106B within a displayed user interface, and/or how to emphasize the associated content (e.g., enlarging, increasing contrast, applying highlighting, animating, changing the color, and/or using other application-defined emphasis techniques). In some embodiments, application module 1114 generates application instructions (e.g., as described with respect to FIGS. 8A-10B and below with respect to instructions 1118) to cause the one or more applications 1116 to display, emphasize, and/or change application content in response to receiving information 1106B. For example, application module 1114 provides an item of information 1106B to an application along with an instruction to the application to display a user interface associated with the item of information 1106B (e.g., an application deep-link) and/or to emphasize associated content within the user interface.

In some embodiments, as another part of a response to user request 1102, response generation module 1104 generates application content 1112, which is provided to application module 1114 to cause (e.g., via an API) one or more applications 1116 to perform one or more tasks based on user request 1102. Accordingly, in some embodiments, application module 1114 provides instructions 1118 to the one or more applications 1116 in response to detecting corresponding events 1106A (e.g., application module 1114 also synchronizes instructions 1118 with the audible output of dialog output 1110, such as described with respect to FIGS. 8A-10B).

For example, application content 1112 includes one or more intents determined based on user request 1102, which application module 1114 operationalizes by providing instructions 1118 (e.g., making API calls) to the one or more applications 1116 to cause the performance of tasks responsive to user request 1102. For example, response tasks include obtaining information (e.g., which may be used to generate dialog content 1106), displaying an application user interface (e.g., via an application deep-link), and/or performing other application tasks (e.g., marking a message in a messaging application as read, creating an event in a calendar application, and/or refreshing a user's queue in a media application). As another example, instructions 1118 include instructions for displaying, emphasizing, and/or changing application content related to the response elements identified by information 1106B.

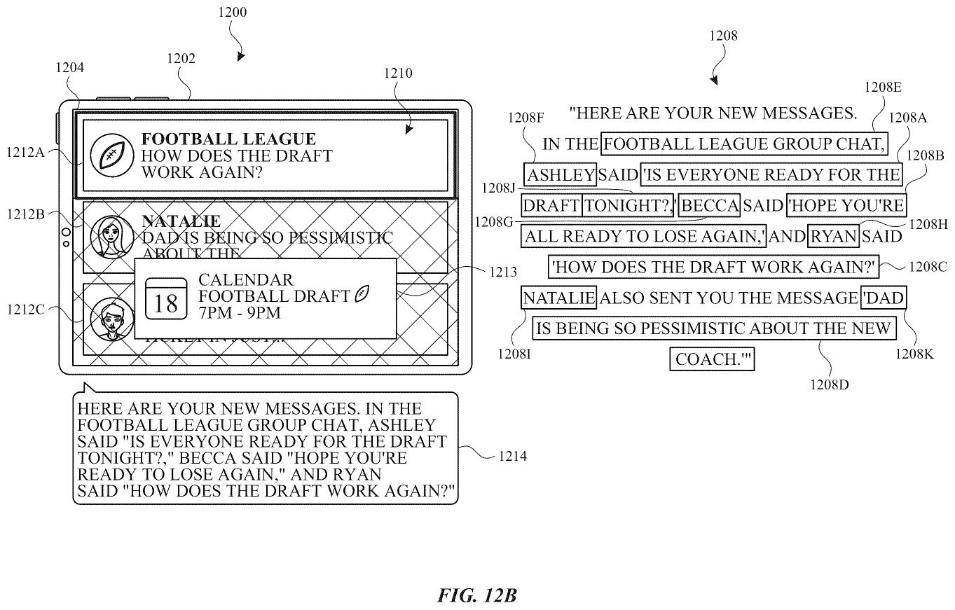

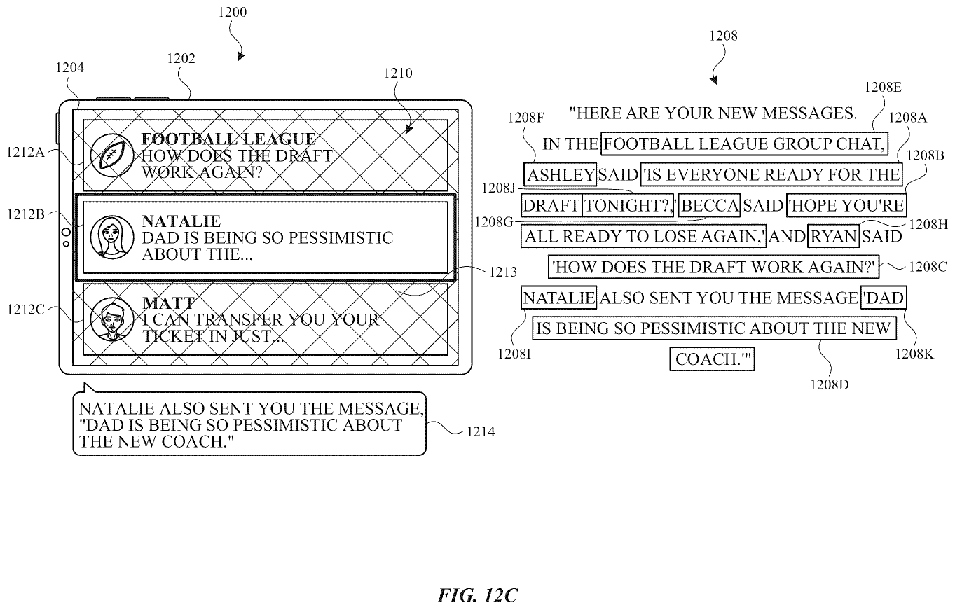

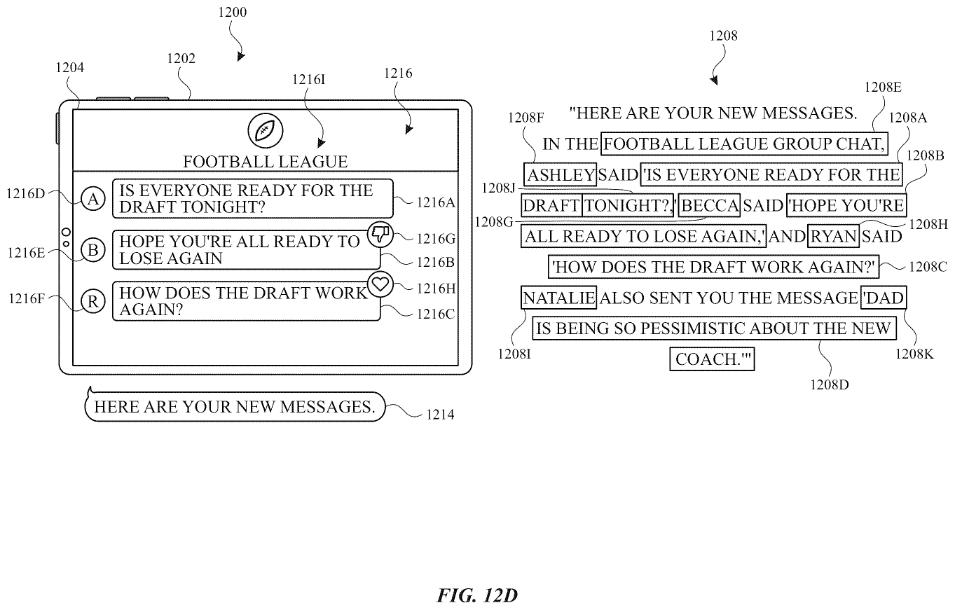

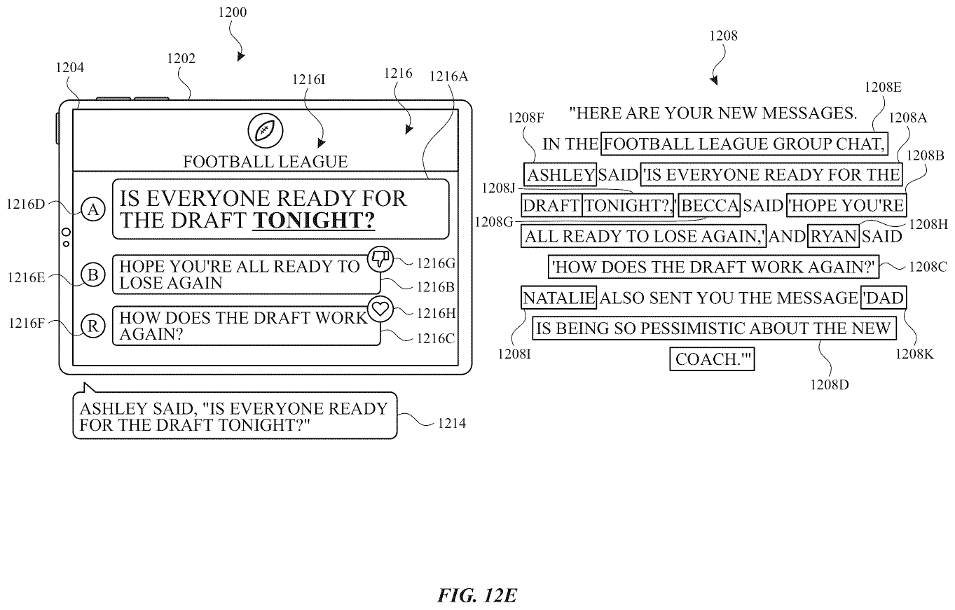

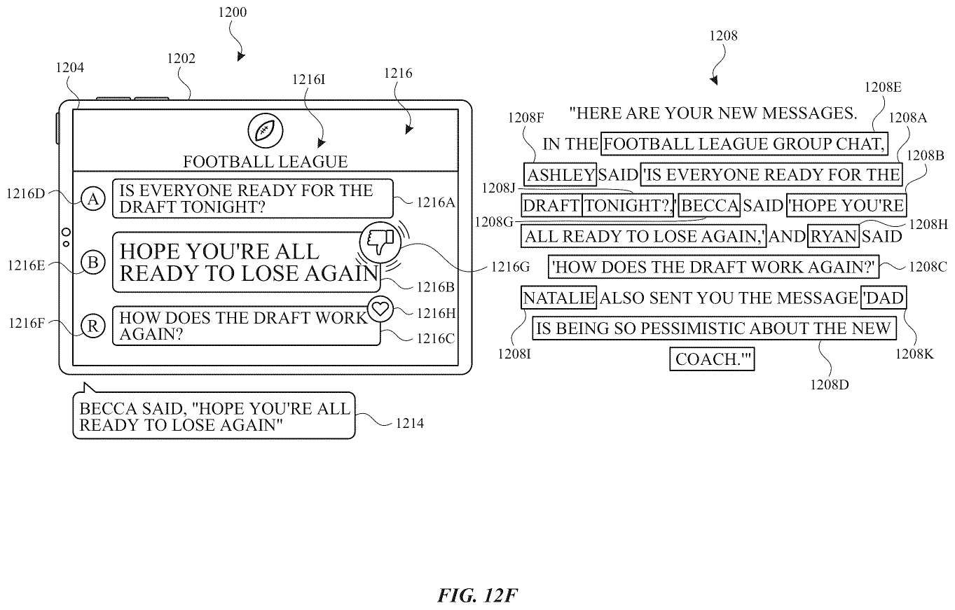

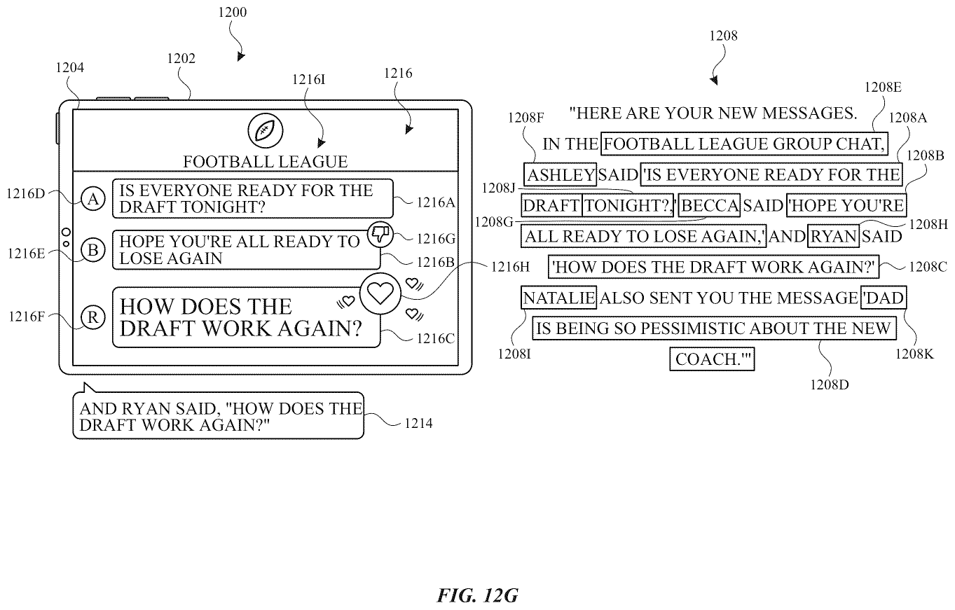

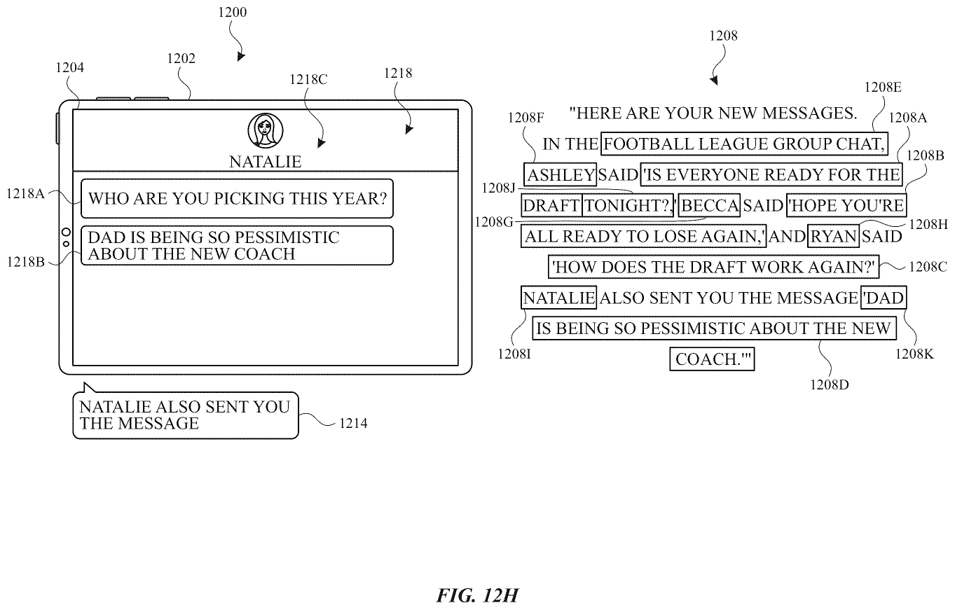

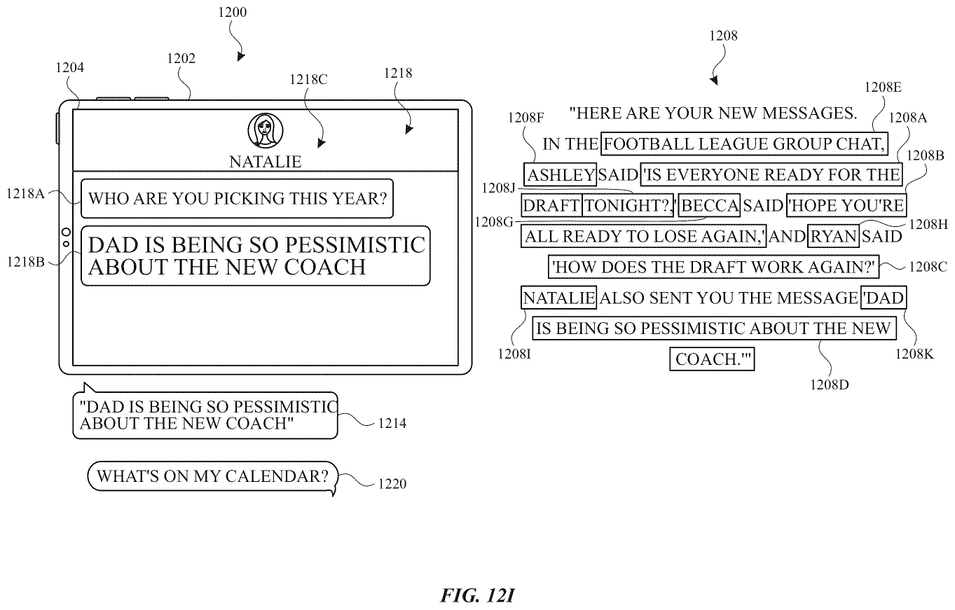

Additional details and examples of application integration into response generation are described herein with respect to FIGS. 12A-12I.

FIGS. 12A-12I illustrate system 1200 for generating responses with application integration, according to various examples. System 1200 is implemented, for example, using one or more electronic devices (e.g., a mobile device, a personal computer, a communal device, a wearable electronic device, and/or a peripheral device) implementing a digital assistant (e.g., digital assistant system 700, e.g., including foundation system 770 and/or system 1100). In some examples, system 1200 is implemented using a client-server system (e.g., system 100), and the functions of system 1200 are divided up in any manner between the server (e.g., DA server 106) and a client device (e.g., 104, 802A, 802B, 802C, and/or 1202). In other examples, the functions of system 1200 are divided up between the server and multiple client devices. Thus, while some functions of system 1200 are described herein as being performed by particular devices of a client-server system, it will be appreciated that system 1200 is not so limited. In other examples, system 1200 is implemented using only a client device (e.g., 104, 802A, 802B, 802C, and/or 1202) or only multiple client devices. In system 1200, some functions are, optionally, combined, the order of some functions is, optionally, changed, and some functions are, optionally, omitted. In some examples, additional functions may be performed in combination with the system 1200.

At FIG. 12A, system 1200 detects request 1206, a spoken input requesting, “Catch me up on messages” As illustrated in FIG. 12A, system 1200 detects request 1206 at device 1202, a tablet computing device with a display 1204 (e.g., such as described with respect to device 802C) implementing system 1100, and/or at another device in communication with device 1202, such as a mobile phone, smart home hub, smart watch, and/or audio peripheral (e.g., headphones, earbuds, and/or speakers). In some embodiments, request 1206 is a request directed to a digital assistant of system 1200 (e.g., digital assistant system 700). For example, request 1206 may be accompanied by a digital assistant trigger (e.g., a spoken trigger, such as “Hey assistant,” a button press, and/or a gesture) provided during an ongoing digital assistant session, identified based on a determination that request 1206 relates to a task that the digital assistant of system 1200 can assist in performing (e.g., a triggerless digital assistant interaction). In some embodiments, request 1206 may be provided using a different type of input, such as a typed input, a button press input associated with providing a summary of messages, and/or inputs setting up an automated message summary task.

In response to detecting request 1206, system 1200 generates dialog content 1208, a textual representation of a natural-language response to request 1206 reading through new messages received by the user via a messaging system and/or messaging application of device 1202 (e.g., “Here are your new messages. In the Football League group chat, Ashley said ‘Is everyone ready for the draft tonight?,’ Becca said ‘Hope you're all ready to lose again,’ and Ryan said ‘How does the draft work again?’ Natalie also sent you the message, ‘Dad is being so pessimistic about the new coach.’”). For example, dialog content 1208 includes generative content (e.g., generating natural-language dialog lead-ins (e.g., “Here are your new messages. In the Football League group chat . . . ” and “Natalie also sent you the message . . . ”), paraphrases/summaries of the messages, and/or follow-up suggestions using an LLM or other dialog model) and application content (e.g., the message contents and metadata retrieved from the messaging application, e.g., via an API).

As illustrated in FIG. 12A, system 1200 annotates (e.g., as described above with respect to response generation module 1104) dialog content 1208 with response element identifiers 1208A-1208K. In particular, system 1200 embeds (e.g., marks up) the portions of dialog content 1208 corresponding to the new messages (e.g., the response list items) with response element identifiers 1208A-1208D, embeds the portions of dialog content 1208 corresponding to conversation information (e.g., sender and/or group chat identities) for the new messages with response element identifiers 1208E-1208I, and embeds portions of dialog content 1208 corresponding to other potential emphasis subjects—the word “tonight,” corresponding to the time of an event, and the word “Dad,” corresponding to a name one of the user's contacts with response element identifiers 1208J-1208K. For example, system 1200 annotates dialog content 1208 based on an analysis of dialog content 1208, application data (e.g., the message contents and metadata retrieved from the messaging application and/or information about the displayed contents of user interface 1210), and/or other contextual data relevant to the response (e.g., device context, user settings/preferences, response context, and/or other context information, as described throughout).

At FIG. 12A, device 1202 displays user interface 1210, a user interface of a messaging application showing a list of messaging conversations 1212A-1212C (e.g., a top-level user interface). In some embodiments, user interface 1210 is displayed when request 1206 is received. In some embodiments, system 1200 causes the messaging application to display (e.g., launch and/or navigate to) user interface 1210 in response to request 1206. For example, system 1200 generates application instructions (e.g., an application deep link) that cause the messaging application to display user interface 1210 (e.g., as described with respect to response generation module 1104). In some embodiments, the messaging application displays user interface 1210 in response to receiving one of response element identifiers 1208A-1208K, which correspond to response information sourced from the messaging application and/or displayed in user interface 1210. For example, system 1200 provides one or more of response element identifiers 1208A-1208K to the messaging application as described below, and the messaging application determines (e.g., using its own internal logic and/or based on display instructions provided by system 1200 with the response element identifiers) to display user interface 1210. Alternatively, in some embodiments, system 1200 causes display of a different user interface in response to request 1206, such as described below with respect to user interfaces 1216 and 1218 in FIGS. 12D-12I.

At FIG. 12B, device 1202 begins to output spoken response 1214, a voice output synthesized from dialog content 1208 (e.g., using a TTS system to convert the text of dialog content 1208 into audible speech), via speakers, headphones, and/or other audio output devices included in and/or connected to device 1202. While outputting spoken response 1214, system 1200 provides one or more of response element identifiers 1208A-1208K to the messaging application, for instance, as described with respect generating and handling events using dialog output module 1108 and application module 1114 of FIG. 11.

In particular, at FIG. 12B, shortly before, during, or after outputting the phrase “Football League group chat,” which is synthesized from the portion of dialog content 1208 embedded with response element identifier 1208E, system 1200 provides response element identifier 1208E to the messaging application. For example, system 1200 provides response element identifier 1208E to the messaging application based on a determination that response element identifier 1208E is associated with messaging conversation 1212A, the list item for the Football League group chat, which is currently displayed within user interface 1210 (e.g., as described with respect to application module 1114 in FIG. 11).

Likewise, while outputting the portion of spoken response 1214 as illustrated in FIG. 12B, system 1200 determines whether or not to provide response element identifiers 1208A, 1208B, 1208F, 1208G, 1208H, and 1208J to the messaging application (e.g., as described with respect to application module 1114 in FIG. 11). For example, shortly before, during, or after outputting the phrase “ . . . and Ryan said ‘How does the draft work again?’ . . . ,” system 1200 provides response element identifiers 1208C and/or 1208H to the messaging application based on a determination that response element identifiers 1208C and/or 1208H are associated with messaging conversation 1212A displayed in user interface 1210, which includes a preview of the new message sent by the contact Ryan. As another example, shortly before, during, or after outputting the respective corresponding portions of spoken response 1214, system 1200 provides response element identifiers 1208A, 1208B, 1208F, 1208G, and/or 1208J to the messaging application based on a determination that response element identifiers 1208A, 1208B, 1208F, 1208G, and/or 1208J are associated with content available in user interfaces 1216 and 1218 of the displayed messaging application (e.g., described below with respect to FIGS. 12D and 12H), even though user interfaces 1216 and 1218 themselves are not currently displayed. As another example, system 1200 determines not to provide response element identifiers 1208A, 1208B, 1208F, 1208G, and/or 1208J to the messaging application based on a determination that response element identifiers 1208A, 1208B, 1208F, 1208G, and/or 1208J are not associated with the specific content displayed in user interface 1210 while outputting the portion of spoken response 1214 as illustrated in FIG. 12B. Accordingly, while outputting spoken response 1214, system 1200 provides the messaging application with the response element identifiers that are relevant and/or potentially relevant to the messaging application and its user interfaces.

As illustrated in FIG. 12B, in response to receiving at least response element identifier 1208E, the messaging application updates user interface 1210 to visually emphasize messaging conversation 1212A (e.g., in comparison to messaging conversations 1212B and 1212C), applying a bold border to messaging conversation 1212A and graying out the other portions of user interface 1210. In some embodiments, other forms of visual emphasis are used, such as enlarging the emphasized content (e.g., as described with respect to FIG. 12E, below), shrinking non-emphasized content, rearranging the content (e.g., bringing the emphasized content to the front, middle, and/or another visually prominent position), highlighting the emphasized content, changing one or more colors of the content, and/or displaying an animation (e.g., a glow, shimmer, and/or sparkle). Accordingly, the content displayed by the messaging application is synchronized with outputting the initial portion of spoken response 1214 including the phrase “Football League group chat.”

As described with respect to FIG. 11, in some embodiments, system 1200 provides response element identifier 1208E to the messaging application with explicit display instructions (e.g., as described with respect to FIGS. 8B-10B) and/or the messaging application determines whether and/or how to update its display content based on the received response element identifiers (e.g., without receiving and/or executing explicit emphasis instructions beyond the provision of the response element identifier). For example, system 1200 provides response element identifier 1208E to the messaging application with instructions to emphasize the corresponding display element for messaging conversation 1212A (e.g., but may allow the messaging application to determine the manner in which to emphasize messaging conversation 1212A). As another example, the messaging application includes internal logic specifying that conversation 1212A should be emphasized if a response element identifying the Football League group chat (e.g., 1208E) and/or a message from therein (e.g., 1208A, 1208B, and/or 1208C) is received. Accordingly, as illustrated in FIG. 12B, in response to receiving response element identifiers 1208C and 1208E, the messaging application emphasizes messaging conversation 1212A in response to receiving response element identifier 1208E. System 1200 thus synchronizes the messaging application with the output timing of spoken response 1214 while allowing the messaging application a level of autonomy and flexibility in controlling whether and how visual outputs are provided.

Additionally or alternatively to emphasizing messaging conversation 1212A as illustrated in FIG. 12B, in some embodiments, in response to receiving response element identifiers 1208A, 1208B, 1208C, 1208E, 1208F, 1208G, 1208H, and/or 1208J, the messaging application (e.g., based on explicit instructions and/or the received response elements) may navigate to user interface 1216 and proceed as described with respect to FIGS. 12D-12G.

In some embodiments, as illustrated in FIG. 12B, system 1200 determines whether or not to provide one or more of the response element identifiers to additional applications other than the messaging application (e.g., the currently-displayed application) while outputting spoken response 1214. For example, while outputting the word “tonight,” system 1200 provides response element identifier 1208J to a calendar application based on a determination that element identifier 1208J is associated with content available in the calendar application, such as a notification user interface (e.g., banner) for an event scheduled in the calendar application for tonight. In response to receiving element identifier 1208J, the calendar application displays notification user interface 1213 with information about a calendar event for the football draft scheduled for 7 PM-9 PM that night. As discussed with respect to the messaging application emphasizing messaging conversation 1212A, in some embodiments, system 1200 provides the calendar application with explicit instructions to display notification user interface 1213 (e.g., based on a determination that user interface 1210 does not include content corresponding to response element identifier 1208J) and/or the calendar application determines to display notification banner 1213 based on its own internal logic. In some embodiments, system 1200 provides the calendar application with additional context information for response element identifier 1208J, such as additional message text (e.g., “the draft tonight”) and/or the sender identity (e.g., response element identifier 1208F), to use in determining how to respond to response element identifier 1208J). For example, the calendar application determines to display notification user interface 1213 in response to receiving response element identifiers and/or associated context information that identify the date, time, or name of the calendar event while the calendar application is not currently being displayed.

At FIG. 12C, device 1202 continues outputting spoken response 1214, and shortly before, during, or after outputting the phrase “Natalie also sent you the message,” which is synthesized from the portion of dialog content 1208 embedded with response element identifier 1208I, system 1200 provides response element identifier 1208I to the messaging application. For example, system 1200 provides response element identifier 1208E to the messaging application based on a determination that response element identifier 1208I is associated with messaging conversation 1212B, the list item for the messaging conversation with the contact Natalie displayed in user interface 1210. As discussed with respect to FIG. 12B, in some embodiments, system 1200 provides response element identifiers 1208D and/or 1208K to the messaging application based on a determination that the identified response elements are associated with user interfaces 1210 and/or 1218 of the messaging application.

As illustrated in FIG. 12C, in response to receiving at least response element identifier 1208I, the messaging application updates user interface 1210 to visually emphasize messaging conversation 1212B, applying the bold border to messaging conversation 1212B and graying out the other portions of user interface 1210. Accordingly, messaging conversation 1212B is emphasized and messaging conversation 1212A is de-emphasized when the delivery of spoken response 1214 reaches the content marked up with response element identifiers related to messaging conversation 1212B. Additionally or alternatively to emphasizing messaging conversation 1212B as illustrated in FIG. 12C, in some embodiments, in response to receiving response element identifiers 1208D, 1208I, and/or 1208K, the messaging application (e.g., based on the received response elements and/or explicit emphasis instructions) may navigate to user interface 1218 and proceed as described with respect to FIGS. 12H-12I.

At FIG. 12D, device 1202 displays user interface 1216, a user interface of the messaging application specific to the Football League group chat (e.g., a lower-level user interface that could be accessed by selecting messaging conversation 1212A from user interface 1210). User interface 1216 is a messaging conversation user interface that includes messages 1216A-1216C, respective sender icons 1216D-1216F, reaction icons 1216G and 1216H, and group chat icon 1216I.

As briefly discussed above, in some embodiments, system 1200 causes the messaging application to navigate to user interface 1216 in response to receiving request 1206 (e.g., as part of a task response plan generated based on a determination of an intent to receive new messages that are represented in user interface 1216) and/or the messaging application navigates to user interface 1216 in response to receiving the response element identifiers associated with user interface 1216 while device 1202 outputs spoken response 1214. For example, in response to receiving response element identifier 1208E corresponding to the Football League group chat; response element identifiers 1208A-1208C and/or 1208J corresponding to messages 1216A-1216C; and/or response element identifiers 1208F-1208H corresponding to the senders of messages 1216A-1216C/sender icons 1216D-1216F, the messaging application navigates to user interface 1216 to display the associated content.

As described with respect to FIGS. 12B-12C, while outputting spoken response 1214, system 1200 provides one or more of response element identifiers 1208A-1208K to the messaging application. At FIG. 12D, while outputting the initial portion of spoken response 1214 including the phrase “Football League group chat,” system 1200 provides the messaging application with response element identifier 1208E (e.g., as described with respect to FIG. 12B); however, the messaging application determines not to update user interface 1216 (e.g., emphasizing group chat icon 1216I) in response to receiving response element identifier 1208E based on the messaging application's internal logic for handling received response element identifiers.

At FIG. 12E, shortly before, during, or after outputting the phrase “Ashley said, ‘Is everyone ready for the draft tonight?’,” system 1200 provides response element identifiers 1208F, 1208A, and 1208J to the messaging application based on a determination that response element identifiers 1208F, 1208A, and 1208J are associated with message 1216A (e.g., the message from Ashley reading “Is everyone ready for the draft tonight?”) and sender icon 1216D (e.g., the sender icon for Ashley) in user interface 1216. For example, system 1200 provides response element identifier 1208F while outputting “Ashley,” provides response element identifier 1208A while outputting “Is everyone ready for the draft tonight?,” and provides response element identifier 1208J while outputting “tonight.”

In response to receiving response element identifiers 1208F, 1208A, and 1208J, the messaging application updates user interface 1216 as illustrated in FIG. 12E. In particular, in response to receiving response element identifiers 1208F, 1208A, and/or 1208J, the messaging application displays message 1216A at a larger size than messages 1216B and 1216C, for instance, animating message 1216A expanding in size and moving messages 1216B and 1216C to accommodate the expansion. Additionally, in response to receiving response element identifier 1208J, the messaging application bolds and underlines the corresponding text “tonight” within message 1216A. As illustrated in FIG. 12E, the messaging application does not visually emphasize sender icon 1216D, the sender icon for Ashley, in response to receiving response element identifier 1208F (e.g., based on internal, developer-defined specifications for handling received response element identifiers).

At FIG. 12F, shortly before, during, or after outputting the phrase “Becca said, “Hope you're all ready to lose again,’” system 1200 provides response element identifiers 1208B and 1208G to the messaging application. For example, system 1200 provides response element identifier 1208G while outputting “Becca” and provides response element identifier 1208B while outputting “Hope you're all ready to lose again.” As illustrated in FIG. 12F, in response to receiving response element identifiers 1208B and/or 1208G, the messaging application visually emphasizes message 1216B (e.g., as described above) and deemphasizes message 1216A. Additionally, the messaging application visually emphasizes reaction icon 1216G, a reaction icon applied to message 1216B in user interface 1216, expanding reaction icon 1216G in size and animating the icon shaking in place. Additionally, the messaging application emphasizes reaction icon 1216G for message 1216B in response to receiving response element identifier 1208B. For example, although the dialog content 1208 does not include natural-language content and/or markup information specifically referring to the reaction content, the messaging application includes internal logic for emphasizing reaction icons based on received response element identifiers.

Likewise, at FIG. 12G, shortly before, during, or after outputting the phrase “and Ryan said, ‘How does the draft work again?’” system 1200 provides response element identifiers 1208C and 1208H to the messaging application. For example, system 1200 provides response element identifier 1208H while outputting “Ryan” and provides response element identifier 1208C while outputting “How does the draft work again?” As illustrated in FIG. 12G, in response to receiving response element identifiers 1208C and/or 1208H, the messaging application visually emphasizes message 1216C (e.g., as described above) and reaction icon 1216H (e.g., expanding reaction icon 1216H in size and applying an application-specified heart icon animation), and deemphasizes message 1216B.

At FIG. 12H, shortly before, during, or after outputting the phrase “Natalie also sent you the message,” system 1200 provides response element identifier 1208I to the messaging application based on a determination that response element identifier 1208I is associated with message 1218A and conversation icon 1218C in user interface 1218, a user interface of the messaging application for a conversation with the contact Natalie (e.g., a lower-level user interface that could be accessed by selecting messaging conversation 1212B from user interface 1210), and, in response, the messaging application displays user interface 1218. For example, as discussed above, system 1200 provides the messaging application response element identifier 1208I along with an explicit instruction to display user interface 1218 (e.g., based on a determination of an intent to receive new messages that are represented in user interface 1218 and/or the determination that response element identifier 1208I is associated with user interface 1218) and/or the messaging application determines to navigate to user interface 1218 based on response element identifier 1208I. User interface 1218 is a messaging conversation user interface that includes messages 1218A and 1218B and conversation icon 1218C.

As described with respect to FIGS. 12E-12G, at FIG. 12I, shortly before, during, or after outputting the phrase “Dad is being so pessimistic about the new coach,” system 1200 provides response element identifiers 1208D and 1208K to the messaging application, and, in response, the messaging application visually emphasizes message 1218B (e.g., the message from Natalie currently being delivered in spoken response 1214). As illustrated in FIG. 12I, in some embodiments, the messaging application determines not to visually emphasize the word “Dad” in message 1218B in response to receiving response element identifier 1208K (e.g., based on the messaging application's internal specifications for handling response element identifiers).

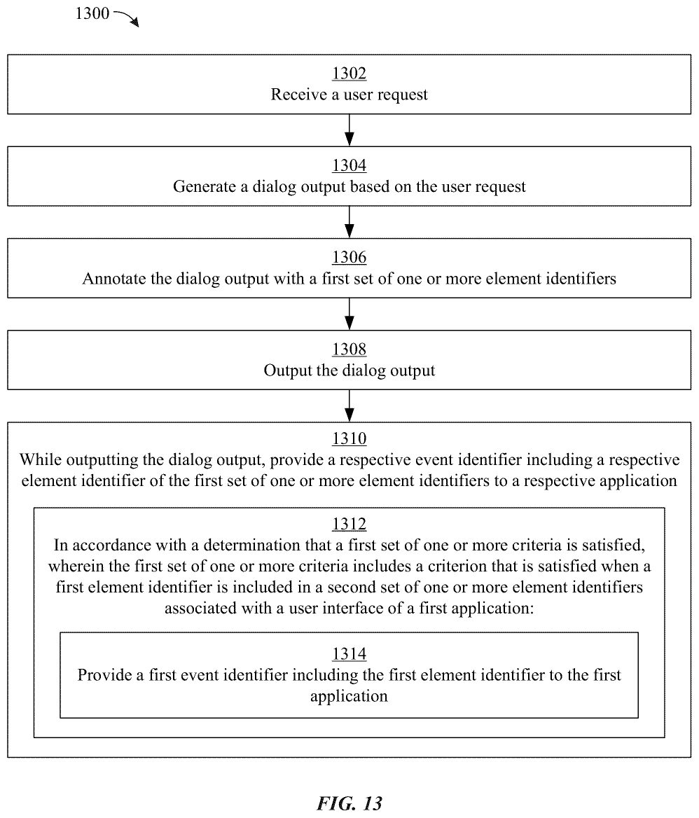

FIG. 13 illustrates a flow diagram of method 1300 for generating responses with application integration, in accordance with some embodiments. Method 1300 may be performed using one or more electronic devices (e.g., 104, 200, 600, 802A, 802B, 802C, 1202). In some embodiments, the electronic device includes and/or is in communication with one or more display generation components (e.g., 804A, 804B, 804C, and/or 1204) (e.g., one or more displays, touch screens, lighting elements, and/or other visual output devices), one or more audio output devices (e.g., speakers, headphones, and/or other audio output components), one or more other output devices, and/or one or more input devices (e.g., microphones, touch-sensitive surfaces, hardware buttons, and/or other input devices). In some embodiments, method 1300 is performed using a client-server system, with the operations of method 1000 divided up in any manner between the client device(s) (e.g., 104, 200, 600, 802A, 802B, 802C, 1202) and the server. In other examples, the blocks of method 1300 are divided up between the server and multiple client devices (e.g., a mobile phone and a smart watch). Thus, while portions of process 1300 are described herein as being performed by particular devices of a client-server system, it will be appreciated that method 1300 is not so limited. In other examples, method 1300 is performed using only a client device (e.g., user device 104) or only multiple client devices. In method 1300, some blocks are, optionally, combined, the order of some blocks is, optionally, changed, and some blocks are, optionally, omitted. In some examples, additional steps may be performed in combination with the method 1300. Some operations in method 1300 are, optionally, combined, the orders of some operations are, optionally, changed, and some operations are, optionally, omitted. Generating responses with application integration as described herein provides improved feedback on a state of the device to a user, which reduces the power usage and improves the battery life of computer systems by enabling the user to use the devices more quickly and efficiently, and improves the quality and efficiency of response generation without sacrificing system flexibility and extensibility (e.g., for third-party applications). For example, digital assistants implementing method 1300 generate spoken responses to user requests while providing synchronization information to relevant applications in order to efficiently leverage the applications' capabilities to provide supplemental outputs, such as display content and user interfaces, which reinforce the user's understanding of the spoken response and reduce the number of user inputs needed to review the information and/or take follow-up actions.

The electronic device receives (1302) a user request (e.g., 806, 814, 820, 1102, and/or 1206). In some embodiments, the user request includes a natural-language input, such as a speech or text input, e.g., “Catch me up on messages,” “Hey Assistant, what shows do I have?,” “Assistant, give me a weather report,” or “Who are the members of Rock Band?” In some embodiments, the user request includes another input corresponding to a request, such as a selection of a suggestion affordance (e.g., “Tap to hear new messages”) or a request to set up an automated feature (e.g., setting up a digital assistant to provide automatic message notifications, weather reports, and/or the like). In some embodiments, the user request includes a trigger, such as a digital assistant trigger (e.g., a phrase such as “Hey Assistant” or “Assistant,” a button press, a user interface input, or a gaze input at a digital assistant user interface object) or an asynchronous trigger (e.g., a request to the digital assistant to provide a response at a certain time or under other conditions).

In response to receiving the user request (1302), the electronic device generates (1304) a dialog output (e.g., 810A, 816, 822, 1106, 1110, 1208, and/or 1214) based on the user request (e.g., as described with respect to FIGS. 11 and 12A). In some embodiments, the dialog output includes a representation of a natural language utterance, such as generative or template-based dialog. For example, a digital assistant system implementing method 1300 includes foundation system 770 and/or one or more other generative AI models (e.g., LLM s) that generates some or all of the dialog output based on the user request (e.g., as a generative content prompt) and/or other contextual information, including information received from applications available and/or installed on the electronic device.

The electronic device annotates (1306) (e.g., embeds) the dialog output with a first set of one or more element identifiers (e.g., 1208A-1208K) (e.g., data objects that identify response elements, such as items in a list, components of a response (e.g., date, time, and location for an event), and/or other subjects or topics of interest) (e.g., as described with respect to FIGS. 11 and 12A). For example, the first set of one or more element identifiers identify a plurality of response subjects and/or elements (e.g., as described with respect to the multi-part responses of methods 900 and/or 1000). For example, a digital assistant system implementing method 1300 determines portions of the dialog output (e.g., words or phrases) that include candidate emphasis subjects and/or other key items of information to be included in the response to the user request, such as names, dates, times, topics, information requested by the user, and/or information potentially relevant to the user request.

The electronic device outputs (1308) the dialog output (e.g., as described with respect to FIGS. 8A-12I). In some embodiments, the dialog output is output as synthesized speech, e.g., using a text-to-speech system to convert a representation of the dialog output (e.g., a textual, phonemic, and/or tokenized representation) into audible speech.

While outputting the dialog output (1308), the electronic device provides (1310) (e.g., via a user interface event handler of a digital assistant system (e.g., application module 1114)) a respective event identifier (e.g., 1106A) (e.g., at least one event identifier) including a respective element identifier (e.g., at least one element identifier) of the first set of one or more element identifiers (e.g., 1208A-1208K) to a respective application (e.g., at least one application) (e.g., as described with respect to FIGS. 11 and 12B-12I). In some embodiments, in addition to the respective element identifier, the respective event identifier includes one or more display or emphasis instructions (e.g., as described with respect to FIGS. 8A-10B) and/or include additional response metadata (e.g., information and/or instructions for display and/or synchronization, such as the type of device being used or the user's current distance from the device, as described with respect to FIGS. 8E-8H).

Providing (1310) the respective event identifier to the respective application includes, in accordance with a determination that a first set of one or more criteria is satisfied (1312), providing (1314) a first event identifier including a first element identifier (e.g., a current element identifier) of the first set of one or more element identifiers to a first application, wherein the first set of one or more criteria includes a criterion that is satisfied when the first element identifier is included in a second set of one or more element identifiers associated with a user interface (e.g., 1210, 1213, 1216, and/or 1218) of the first application (e.g., as described with respect to FIGS. 12B-12I) (e.g., element identifiers corresponding to UI elements of a currently-displayed UI and/or a UI that could or will be displayed as part of the response). For example, if the dialog output refers to an element that is or could be displayed by a user interface of the application, the event handler generates an event to pass to the application to inform the application that relevant or potentially information is being output, thus coordinating the application response (e.g., the visual output provided via a user interface of an application) with the spoken response. For example, providing the event identifier to the application is performed as described with respect to methods 900 and 1000 with respect to providing response elements and/or emphasis instructions to the applications.

In some embodiments, the user request is received while displaying, via a display generation component in communication with the electronic device, the user interface of the first application (e.g., as described with respect to FIG. 12A). For example, in response to receiving the first event identifier, the application modifies the currently-displayed user interface (e.g., emphasizing, moving, and/or otherwise changing the appearance of the corresponding element).

In some embodiments, in response to receiving the user request, the electronic device displays, via the display generation component, the user interface of the first application (e.g., as described with respect to FIGS. 11, 12A, 12D, and/or 12H). In some embodiments, the electronic device causes the user interface of the first application to be displayed as part of a task response to the user request. In some embodiments, providing the first event identifier to the first application causes the user interface of the first application to be displayed. For example, the first event identifier includes a deep link to open (e.g., display/navigate to) the user interface within the application and/or the application includes logic for launching the user interface in response to receiving the first event identifier.

In some embodiments, the first event identifier includes a display instruction (e.g., 813A and/or 813B) (e.g., an application intent, application deep link, and/or other response plan instructions) for a visual output including a first display element (e.g., 812A-812B, 818A-818C, 824A-824D, 1212A, 1212B, 1213, 1216A-1216H, and/or 1218A-1218C) corresponding to the first element identifier, and providing the first event identifier to the first application causes the first application to display the first visual output (e.g., as described with respect to FIGS. 8A-12I). In some embodiments, providing the first event identifier to the first application causes the first application to display the user interface (e.g., 812A, 812B, 818, 824, 1210, 1213, 1216, and/or 1218) including the first display element (e.g., as described with respect to FIGS. 8A-10B, 12A, 12D, and/or 12H) (e.g., the display instruction includes an application deep link to application content associated with the first element identifier).

In some embodiments, providing the first event identifier to the first application causes the first application to modify (e.g., temporarily modify) an appearance of the first display element (e.g., as described with respect to FIGS. 8A-10B, 12B-12C and 12E-12I) (e.g., highlighting, resizing, moving, animating, emphasizing, and/or otherwise changing the display of the first display element from its default state).

Additionally or alternatively, in some embodiments, the first application includes internal (e.g., developer-defined) logic for displaying visual outputs (e.g., user interfaces, display elements, and/or modifications thereto) based on the first event identifier, which may supplement and/or override the included display instruction. For example, a digital assistant implementing method 1300 may include highly-specific instructions for the first visual output (e.g., an instruction to display and/or modify the appearance of the first display element in a particular manner) or more generalized instructions (e.g., an instruction to display the user interface including the first display element, but not specifying whether or how to emphasize it), leaving certain specifics of providing the first visual output to the application logic. In some embodiments, an application may define logic for, in response to receiving an event, determining whether an element identified by the event satisfies emphasis criteria for a corresponding user interface element within a user interface of the application and, if so, displaying and/or updating the display of the corresponding user interface element, the user interface, and/or other display elements (e.g., as described with respect to FIGS. 12B-12I, illustrating various display responses using the messaging and calendar applications).

In some embodiments, the first set of one or more criteria includes a criterion that is satisfied when (e.g., shortly before, during, and/or after) outputting a portion of the dialog output that is annotated (e.g., embedded and/or marked up) with the first element identifier (e.g., as described with respect to FIGS. 11 and 12B-12I). For example, the dialog output is annotated (e.g., marked up) to identify display elements that are relevant to the contents of different portions of the dialog, such that outputting an annotated portion of the dialog generates an event to convey the currently-relevant element identifier to the application. In some embodiments, providing the respective event identifier to the respective application includes, in accordance with a determination that a second set of one or more criteria is satisfied, providing a second event identifier including a second element identifier, different than the first element identifier, of the first set of one or more element identifiers to a second application (in some embodiments, the second application is the same application as the first application or a different application), wherein the second set of one or more criteria includes a criterion that is satisfied when outputting a portion of the dialog output that is annotated (e.g., marked up) with the second element identifier (e.g., as described with respect to FIGS. 11 and 12B-12I). For example, the first and second sets of criteria may be satisfied by the same portion of dialog (e.g., a portion of dialog annotated with both the first and second element identifiers) and/or by different portions of dialog (e.g., generating different event identifiers at different points in the dialog output). In some embodiments, the second set of one or more criteria includes a criterion that is satisfied when the second element identifier is included in a set of one or more element identifiers associated with a second user interface (in some embodiments, the same user interface as the user interface of the first application and or a different user interface) of the second application. For example, as described with respect to FIGS. 12B-12I, while outputting spoken response 1214, system 1200 provides the messaging application with response element identifier 1208F while outputting the word “Ashley,” provides the messaging application with response element identifier 1208A while outputting the phrase “Is everyone ready for the draft tonight?,” provides the messaging application with response element identifier 1208J while outputting the word “tonight,” and so forth.

In some embodiments, providing the respective event identifier to the respective application includes, in accordance with a determination that a third set of one or more criteria is satisfied, providing a third event identifier including a third element identifier (e.g., the current element identifier) of the first set of one or more element identifiers to a third application that is different than the first application (e.g., as described with respect to FIGS. 11 and 12B), wherein the third set of one or more criteria includes a criterion that is satisfied when the third element identifier is included in a third set of one or more element identifiers associated with a user interface of the third application (e.g., 1213) (e.g., generated events are passed to multiple different applications that includes contents relevant to the elements identified by the events). For example, as described with respect to FIG. 12B, while outputting the word “tonight,” system 1200 provides both the messaging application and the calendar application with response element identifier 1208J. In some embodiments, if an annotated element identifier is not included in any set of element identifiers associated with an application (e.g., if the identified element is not relevant to any of the applications in focus, open, installed, and/or otherwise available to the system while outputting the dialog output), the event identifier is not provided to any application.

In some embodiments, providing the respective event identifier to the respective application includes, in accordance with a determination that a fourth set of one or more criteria is satisfied, providing a fourth event identifier including a fourth element identifier, different than the first element identifier, of the first set of one or more element identifiers to the first application, wherein the fourth set of one or more criteria includes a criterion that is satisfied when the fourth element identifier is included in a fourth set of one or more element identifiers associated with a respective user interface of the first application (e.g., an application is provided with multiple events corresponding to multiple elements that are relevant to the application, as described with respect to FIGS. 12B-12I). In some embodiments, if none of the element identifiers in the first set of element identifiers (e.g., the annotated element identifiers) is included in one or more sets of element identifiers associated with an application, the application is not provided with any events

Note that details of the processes described above with respect to method 1300 (e.g., FIG. 13) are also applicable in an analogous manner to the other systems methods described above. For example, the application integration described with respect to method 1300 can be used to generate and coordinate application content when providing multi-part responses as described with respect to methods 900 and 1000, and the response synchronization described with respect to methods 900 and 1000 can be applied to multi-part responses with integrated application content as described with respect to method 1300. For brevity, these details are not repeated herein.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

In accordance with some implementations, a computer system is provided that comprises means for performing any of the methods or processes described herein.

In accordance with some implementations, a computer system is provided that comprises a processing unit configured to perform any of the methods or processes described herein.

In accordance with some implementations, a computer system is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the accuracy and relevance of system responses to user requests. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine and generate digital assistant responses to user requests that reflect user preferences. Accordingly, use of such personal information data provides users with improved digital assistant functionality. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of generating digital assistant responses, the present technology can be configured to allow users to select to “opt in” or “opt out” of participation in the collection of personal information data during registration for services or anytime thereafter. In another example, users can select not to provide mood-associated data for digital assistant responses. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, accurate and relevant digital assistant responses can be generated by inferring preferences based on non-personal information data or a bare minimum amount of personal information, such as the content being requested by the device associated with a user, other non-personal information available to the digital assistant system, or publicly available information.

What is claimed is:

1. An electronic device, comprising:
one or more processors;
a memory; and
one or more programs, wherein the one or more programs are stored in the memory and configured to be executed by the one or more processors, the one or more programs including instructions for:
receiving a user request directed to a digital assistant system;
in response to receiving the user request directed to the digital assistant system, outputting, via the digital assistant system, a speech output; and
causing display, via a display generation component, of a visual output, wherein causing the display of the visual output includes:
in accordance with a determination that synchronization criteria are satisfied:
causing display of the visual output in a first display state at a first time while outputting the speech output; and
causing display of the visual output in a second display state, different from the first display state, at a second time, different from the first time, while outputting the speech output.

2. The electronic device of claim 1, wherein:
the speech output includes a first utterance associated with a first subject and a second utterance associated with a second subject that is different from the first subject;
causing display of the visual output in the first display state includes causing display of first content associated with the first subject; and
causing display of the visual output in the second display state includes causing display of second content associated with the second subject.

3. The electronic device of claim 2, wherein:
the first utterance includes a first word corresponding to the first subject;
the second utterance includes a second word corresponding to the second subject;
the first content corresponding to the first subject includes text of the first word; and
the second content corresponding to the second subject includes text of the second word.

4. The electronic device of claim 3, wherein:
causing display of the visual output in the first display state includes visually emphasizing the text of the first word; and
causing display of the visual output in the second display state includes visually emphasizing the text of the second word.

5. The electronic device of claim 2, wherein the speech output includes a third utterance corresponding to a third subject that is different from the first subject and the second subject, the one or more programs further including instructions for:
in accordance with the determination that the synchronization criteria are satisfied:
at a third time while outputting the speech output that is different from the first time and the second time, causing display of the visual output in a third display state that is different from the first display state and the second display state, wherein causing display of the visual output in the third display state includes causing display of third content corresponding to the third subject.

6. The electronic device of claim 1, wherein causing display of the visual output includes:
generating a set of instructions including a first instruction for displaying the visual output in the first display state and a second instruction for displaying the visual output in the second display state.

7. The electronic device of claim 6, wherein generating the set of instructions is performed in response to receiving the user request directed to the digital assistant system.

8. The electronic device of claim 6, wherein causing the display of the visual output includes providing the set of instructions to a set of one or more applications.

9. The electronic device of claim 8, the one or more programs further including instructions for:
obtaining, from the set of one or more applications, metadata identifying a plurality of display states including the first display state and the second display state;
wherein generating the set of instructions includes:
in accordance with a determination, based on the metadata, that the speech output includes an utterance associated with the first display state, generating the first instruction for displaying the visual output in the first display state; and
in accordance with a determination, based on the metadata, that the speech output includes an utterance associated with the second display state, generating the second instruction for displaying the visual output in the second display state.

10. The electronic device of claim 8, wherein providing the set of instructions to the set of one or more applications includes:
while outputting, via the digital assistant system, a fourth utterance of the speech output, providing the first instruction for displaying the visual output in the first display state to a first application of the set of one or more applications; and
while outputting, via the digital assistant system, a fifth utterance of the speech output, providing the first instruction for displaying the visual output in the first display state to a second application of the set of one or more applications.

11. The electronic device of claim 10, wherein outputting the fourth utterance is performed at the first time and outputting the fifth utterance is performed at the second time.

12. The electronic device of claim 10, the one or more programs further including instructions for:
in response to receiving the user request directed to the digital assistant system:
generating a representation of the speech output;
encoding a portion of the representation of the speech output that corresponds to the fourth utterance with at least a portion of the first instruction for displaying the visual output in the first display state; and
encoding a portion of the representation of the speech output that corresponds to the fifth utterance with at least a portion of the second instruction for displaying the visual output in the second display state.

13. The electronic device of claim 6, wherein:
the first instruction for displaying the visual output in the first display state includes an instruction to display the visual output in the first display state at the first time; and
the second instruction for displaying the visual output in the second display state includes an instruction to display the visual output in the second display state at the second time.

14. The electronic device of claim 13, wherein the first time is an estimated time of delivery of a sixth utterance of the speech output and the second time is an estimated time of delivery of a seventh utterance.

15. The electronic device of claim 1, wherein causing display of the visual output includes causing display of a user interface.

16. The electronic device of claim 15, wherein the user interface includes an application user interface.

17. The electronic device of claim 15, wherein:
causing display of the visual output in the first display state includes causing display of the user interface including third content and not including fourth content; and
causing display of the visual output in the second display state includes causing display of the user interface including the fourth content and not including the third content.

18. The electronic device of claim 15, wherein:
causing display of the visual output in the first display state includes causing a first element of the user interface to be visually emphasized; and
causing display of the visual output in the second display state includes causing a second element of the user interface, different from the first element, to be visually emphasized.

19. The electronic device of claim 15, wherein:
causing display of the visual output in the first display state includes causing a third element to be displayed at a first position in the user interface; and
causing display of the visual output in the second display state includes causing a fourth element to be displayed at a second position in the user interface.

20. The electronic device of claim 1, wherein the synchronization criteria include a first criterion that is satisfied when the display has a first form factor.

21. The electronic device of claim 1, wherein the synchronization criteria include a first proximity criterion that is satisfied when a detected proximity of a user is within a threshold proximity range.

22. The electronic device of claim 21, wherein causing the display of the visual output includes:
in accordance with a determination that the first proximity criterion is not satisfied:
causing display of the visual output in a respective display state at a respective time while outputting the speech output.

23. The electronic device of claim 1, wherein the synchronization criteria include a content criterion that is satisfied when the visual output includes content of a respective type.

24. The electronic device of claim 1, wherein causing the display of the visual output includes:
in accordance with a determination that the synchronization criteria are not satisfied:
causing display of the visual output in a fourth display state at a fourth time while outputting the speech output; and
foregoing causing display of the visual output in a display state other than the fourth display state while outputting the speech output.

25. The electronic device of claim 1, the one or more programs further including instructions for:
in response to receiving the user request directed to the digital assistant system, generating, via the digital assistant system, the speech output, wherein the speech output includes synthesized speech.

26. A method, comprising:
at an electronic device with one or more processors and memory:
receiving a user request directed to a digital assistant system;
in response to receiving the user request directed to the digital assistant system, outputting, via the digital assistant system, a speech output; and
causing display, via a display generation component, of a visual output, wherein causing the display of the visual output includes:
in accordance with a determination that synchronization criteria are satisfied:
causing display of the visual output in a first display state at a first time while outputting the speech output; and
causing display of the visual output in a second display state, different from the first display state, at a second time, different from the first time, while outputting the speech output.

27. A non-transitory computer-readable storage medium storing one or more programs, the one or more programs comprising instructions, which when executed by one or more processors of an electronic device, cause the electronic device to:
receive a user request directed to a digital assistant system;
in response to receiving the user request directed to the digital assistant system, output, via the digital assistant system, a speech output; and
cause display, via a display generation component, of a visual output, wherein causing the display of the visual output includes:
in accordance with a determination that synchronization criteria are satisfied:
causing display of the visual output in a first display state at a first time while outputting the speech output; and
causing display of the visual output in a second display state, different from the first display state, at a second time, different from the first time, while outputting the speech output.
